(19) United States
(12) Patent Application Publication
(10) Pub. No.: US 2017/0243591 A1
(43) Pub. Date: Aug. 24, 2017

(54) COMMUNICATION TERMINAL DEVICE, COMMUNICATION SYSTEM, COMMUNICATION METHOD, RECORDING MEDIUM FOR TRANSMITTING SPEECH DATA

(71) Applicant: JVC KENWOOD Corporation, Yokohama-shi (JP)

(72) Inventor: Jun TANAKA, Yokohama-shi (JP)

(73) Assignee: JVC KENWOOD Corporation, Yokohama-shi (JP)

(21) Appl. No.: 15/592,317

(22) Filed: May 11, 2017

Related U.S. Application Data
(63) Continuation of application No. PCT/JP2015/073241, filed on Aug. 19, 2015.

(30) Foreign Application Priority Data
Nov. 21, 2014 (JP) 2014-236659
Nov. 21, 2014 (JP) 2014-236660

(51) Int. Cl. G10L 19/022; H04W 52/24; G10L 25/48; H04W 72/12

(52) U.S. Cl. CPC G10L 19/022; H04W 72/1231; H04W 52/241; G10L 25/48

(57) ABSTRACT

A microphone receives speech data to be transmitted. A business wireless communication unit transmits the received speech data. A processing unit causes a storage unit to store the speech data and time information for identifying blocks produced by dividing the received speech data into a plurality of blocks. The business wireless communication unit receives a request signal for requesting transmission of the speech data stored in the storage unit, the request signal including the time information. The processing unit acquires from the storage unit the speech data for the block identified based on the time information included in the received request signal, and causes the business wireless communication unit to transmit the acquired speech data.

### CROSS-REFERENCE TO RELATED APPLICATION

This application is based upon and claims the benefit of priority from the prior Japanese Patent Application No.2014-236659, filed on Nov. 21, 2014, and Japanese Patent Application No.2014-236660, filed on Nov. 21, 2014, the entire contents of which are incorporated herein by reference.

### BACKGROUND

1. Field

The present invention relates to communication technologies and, more particularly, to communication terminal devices, communication systems, communication methods, and recording mediums for transmitting speech data.

2. Description of the Related Art

Communication terminal devices such as cellular phones are capable of making a call from any place as needed and are used for emergency notification. If the communication terminal device is located outside a service area of a mobile communication network, however, the communication terminal device cannot make a call or give an emergency notification. In order to address this issue, a cellular phone is provided with an emergency button, a digital camera, a microphone, and an image and speech data storage unit, and stores image data from the digital camera and speech data from the microphone in the image and speech data storage unit when the emergency button is pressed for a predetermined period of time. The cellular phone within a service area automatically originates an emergency call and transmits image data, speech data, and time data in response to a transmission request signal from a police station. If the cellular phone is outside a service area, the image data and speech data stored in the image and speech data storage unit are transmitted when the cellular phone moves into the service area (e.g., Patent Document 1).

[Patent Document 1] JP2003-217060

A speech received in business wireless communication needs to be reconstructed with a minimum delay. Therefore, a communication terminal device for business wireless communication converts a received signal into a speech signal and immediately outputs the speech signal from a speaker. Further, the communication terminal device stores received a speech in a recording medium. It is therefore possible to check the content of a conversation later or check the speech that is missed. However, the speech is merely stored in a recording medium so that the content of a conversation cannot be checked using communication.

### SUMMARY

To address the above issue, a communication terminal device according to an embodiment comprises: a reception unit that receives speech data to be transmitted; a communication unit that transmits the speech data received in the reception unit; and a processing unit that stores, in a memory, the speech data and time information for identifying blocks produced by dividing the speech data received in the reception unit into a plurality of blocks. The communication receives a request signal for requesting transmission of the speech data stored in the memory, the request signal including the time information, and the processing unit acquires from the memory the speech data for the block identified based on the time information included in the request signal received in the communication unit and causes the communication unit to transmit the acquired speech data.

Another embodiment also relates to a communication terminal device. The device comprises: a reception unit that receives speech data to be transmitted; a communication unit that transmits the speech data and numbering information for identifying blocks produced by dividing the speech data received in the reception unit into a plurality of blocks; and a processing unit that stores, in a memory, the speech data received in the reception unit and the numbering information. The communication unit receives a request signal for requesting transmission of the speech data stored in the memory, the request signal including the numbering information, and the processing unit acquires from the memory the speech data for the block identified based on the numbering information included in the request signal received in the communication unit and causes the communication unit to transmit the acquired speech data.

Another embodiment also relates to a communication terminal device. The device comprises: a reception unit that receives speech data to be transmitted; a communication unit that transmits the speech data received in the reception unit; a sensing unit that senses degradation in a communication environment used in the communication unit; and a processing unit that stores, in a memory, the speech data received in the reception unit after the sensing unit senses degradation in the communication environment. The communication unit receives a request signal for requesting transmission of the speech data stored in the memory, and the processing unit acquires from the memory the speech data when the communication unit receives the request signal and causes the communication unit to transmit the acquired speech data.

Another embodiment relates to a communication system. The communication system comprises: a first communication terminal device that receives speech data to be transmitted, transmits the received speech data, and stores, in a memory, the speech data and time information for identifying blocks produced by dividing the received speech data into a plurality of blocks; and a second communication terminal device that receives the speech data from the first communication terminal device.

The second communication unit transmits a request signal for requesting transmission of the speech data stored in the memory of the first communication terminal device, the request signal including the time information, and the first communication terminal device acquires from the memory the speech data for the block identified based on the time information included in the received request signal and transmits the acquired speech data.

Another embodiment also relates to a communication system. The communication system comprises: a first communication terminal device that receives speech data to be transmitted, transmits the speech data and numbering information for identifying blocks produced by dividing the received speech data into a plurality of blocks, and stores in a memory the received speech data and the numbering information; and a second communication terminal device that receives the speech data and the numbering information from the first communication terminal device. The second communication terminal device transmits a request signal for requesting transmission of the speech data stored in the memory of the first communication terminal device, the request signal including the numbering information, and the first communication terminal device acquires from the memory the speech data for the block identified based on the numbering information included in the received request signal, and transmits the acquired speech data.

Another embodiment relates to a communication method. The method comprises: receiving, using a first communication terminal device, speech data to be transmitted, transmitting the received speech data, and storing, in a memory, the speech data and time information for identifying blocks produced by dividing the received speech data into a plurality of blocks; receiving, using a second communication terminal device, the speech data from the first communication terminal device; transmitting, using the second communication terminal device, a request signal for requesting transmission of the speech data stored in the memory of the first communication terminal device, the request signal including the time information; and acquiring, using the first communication terminal, the speech data for the block identified based on the time information included in the received request signal from the memory, and transmitting the acquired speech data.

Another embodiment relates to a communication method. The method comprises: receiving, using a first communication terminal device, speech data to be transmitted, transmitting the speech data and numbering information for identifying blocks produced by dividing the received speech data into a plurality of blocks, and storing the received speech data and the numbering information; receiving, using a second communication terminal device, the speech data and the numbering information from the first communication terminal device; transmitting, using the second communication terminal device, a request signal for requesting transmission of the speech data stored in the memory of the first communication terminal device, the request signal including the numbering information; and acquiring, using the first first communication terminal, the speech data for the block identified based on the time information included in the received request signal from the memory, and transmitting the acquired speech data.

Another embodiment relates to a communication method. The method comprises: receiving, using a first communication terminal device, speech data to be transmitted and transmitting the received speech data; receiving, using a second communication terminal device, the speech data from the first communication terminal device; storing, using the first communication terminal device, the received speech data in a memory after sensing degradation in a communication environment; transmitting, using the second communication terminal device, a request signal for requesting transmission of the speech data stored in the memory of the first communication terminal device; and acquiring, using the first communication terminal device, the speech data from the memory when the request signal is received, and transmitting the acquired speech data.

Another embodiment also relates to a communication terminal device. The device comprises: a first communication unit that performs communication using a first communication scheme; a second communication unit that performs communication using a second communication scheme different from the first communication scheme in the first communication unit; a reception unit that receives speech data to be transmitted; and a processing unit that causes the second communication unit to transmit the speech data received in the reception unit and causes a memory to store the speech data. The second communication unit stops transmission of the speech data when a remaining life of a battery driving the communication terminal device goes lower than a threshold value, the first communication unit receives a request signal for requesting transmission of the speech data stored in the memory, the processing unit causes the first communication unit to transmit the speech data acquired from the memory when the first communication unit receives the request signal, and a transmission power in the first communication unit is smaller than a transmission power in the second communication unit.

Another embodiment also relates to a communication terminal device. The device comprises: a first communication unit that performs communication using a first communication scheme; and a second communication unit that performs communication using a second communication scheme different from the first communication scheme in the first communication unit. The second communication unit receives speech data from a transmitting end, the first communication unit transmits a request signal for requesting transmission of the speech data stored in a memory of the transmitting end if a period of time that the speech data is not received in the second communication unit is longer than a predetermined period of time, and receives the speech data stored in the memory of the transmitting end in response to the request signal transmitted, and a transmission power in the first communication scheme is smaller than a transmission power in the second communication scheme.

Another embodiment also relates to a communication terminal device. The device comprises: a first communication unit that performs communication using a first communication scheme; and a second communication unit that performs communication using a second communication scheme different from the first communication scheme in the first communication unit. The second communication unit receives speech data from a transmitting end, at least one of the first communication unit and the second communication unit is notified of a stop of transmission of speech data from the transmitting end, the first communication unit transmits a request signal for requesting transmission of the speech data stored in a memory of the transmitting end when notified of the stop of transmission, and receives the speech data stored in the memory of the transmitting end in response to the request signal transmitted, and a transmission power in the first communication scheme is smaller than a transmission power in the second communication scheme.

Another embodiment also relates to a communication system. The communication system comprises: a first communication terminal device capable of performing communication using a first communication scheme and a second communication scheme that are mutually different and constructed to receive speech data to be transmitted, to transmit the received speech data using the second communication scheme, and to store the speech data in a memory; and a second communication terminal device capable of performing communication using the first communication scheme and the second communication scheme and constructed to receive the speech data using the second communication scheme. The first communication terminal device stops transmitting the speech data using the second communication scheme when a remaining life of a battery goes lower than a threshold value, the second communication terminal device transmits a request signal for requesting transmission of the speech data stored in the memory of the first communication terminal device using the first communication scheme if a period of time that the speech data is not received in the second communication scheme is longer than a predetermined period of time, the first communication terminal device transmits the speech data acquired from the memory using the first communication scheme when the request signal is received, and a transmission power in the first communication scheme is smaller than a transmission power in the second communication scheme.

Another embodiment also relates to a communication system. The communication system comprises: a first communication terminal device capable of performing communication using a first communication scheme and a second communication scheme that are mutually different and constructed to receive speech data to be transmitted, to transmit the received speech data using the second communication scheme, and to store the speech data in a memory; and a second communication terminal device capable of performing communication using the first communication scheme and the second communication scheme and constructed to receive the speech data using the second communication scheme. The first communication unit stops transmission of the speech data using the second communication scheme when a remaining battery life goes lower than a threshold value, communicates a stop of transmission using the first communication scheme or the second communication scheme, the second communication terminal device transmits a request for requesting transmission of the speech data stored in the memory of the first communication terminal device when notified of the stop of transmission, the first communication terminal device transmits the speech data acquired from the memory using the first communication scheme when the request signal is received, and a transmission power in the first communication unit is smaller than a transmission power in the second communication unit.

Another embodiment also relates to a communication method. The method comprises: receiving, using a first communication terminal device capable of performing communication using a first communication scheme and a second communication scheme that are mutually different, a transmission power in the first communication scheme being smaller than a transmission power in the second communication scheme, speech data to be transmitted, transmitting the received speech data using the second communication scheme, and storing the speech data in a memory; receiving, using a second communication terminal device capable of performing communication using the first communication scheme and the second communication scheme, the speech data using the second communication scheme, stopping, using the first communication terminal device, transmission of the speech data using the second communication scheme when a remaining battery life goes lower than a predetermined threshold value; transmitting, using the second communication terminal, a request signal for requesting transmission of the speech data stored in the memory of the first communication terminal device using the first communication scheme if a period of time that the speech data is not received using the second communication scheme is longer than a predetermined period of time; and transmitting, using the first communication terminal device, the speech data acquired from the memory using the first communication scheme when the request signal is received.

Another embodiment also relates to a communication method. The method comprises: receiving, using a first communication terminal device capable of performing communication using a first communication scheme and a second communication scheme that are mutually different, a transmission power in the first communication scheme being smaller than a transmission power in the second communication scheme, speech data to be transmitted, transmitting the received speech data using the second communication scheme, and storing the speech data in a memory; receiving, using a second communication terminal device capable of performing communication using the first communication scheme and the second communication scheme, the speech data using the second communication scheme, stopping, using the first communication terminal device, transmission of the speech data using the second communication scheme when a remaining battery life goes lower than a predetermined threshold value, and communicating a stop of transmission using the first communication scheme or the second communication scheme; transmitting, using the second communication terminal, a request signal for requesting transmission of the speech data stored in the memory of the first communication terminal device using the first communication scheme when the second communication terminal device is notified of the stop of transmission; and transmitting, using the first communication terminal device, the speech data acquired from the memory using the first communication scheme when the request signal is received.

Optional combinations of the aforementioned constituting elements, and implementations of the embodiments in the form of methods, apparatuses, systems, recording mediums, and computer programs may also be practiced as additional modes of the embodiments.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of a communication system according to Embodiment 1;

FIG. 2 shows the features of the first communication terminal device of FIG. 1;

FIG. 3 shows the features of the second communication terminal device of FIG. 1;

FIG. 4 shows time information assigned in the assignment unit of FIG. 2;

FIGS. 5A, 5B and 5C show screens displayed on the monitor of FIG. 4;

FIG. 6 is a sequence diagram showing the steps of transmitting speech data in the communication system of FIG. 1;

FIG. 7 is a sequence diagram showing the steps of transmitting the speech data by the first communication terminal device of FIG. 2;

FIG. 8 is a sequence diagram showing the steps of receiving the speech data by the second communication terminal device of FIG. 2;

FIG. 9 is a flowchart showing the steps of generating speech data by the first communication terminal device of FIG. 2; FIG. 10 is a flowchart showing the steps of detecting degradation by the communication environment in the second communication terminal device of FIG. 3;

FIG. 11 is a flowchart showing the steps of receiving the speech data by the second communication terminal device of FIG. 3;

FIG. 12 shows the features of the first communication terminal device according to Embodiment 2;

FIG. 13 shows the features of the first communication terminal device according to Embodiment 3;

FIG. 14 is a sequence diagram showing the steps of transmitting the speech data by the communication system according to Embodiment 3;

FIG. 15 shows the features of the communication system according to Embodiment 4;

FIG. 16 shows the features of the communication terminal device of FIG. 15;

FIG. 17 shows the features of the first communication terminal device according to Embodiment 5;

FIG. 18 shows the features of the second communication terminal device according to Embodiment 5;

FIG. 19 is a sequence diagram showing the steps of transmitting the speech data by the communication system according to Embodiment 5;

FIG. 20 is a sequence diagram showing the steps of transmitting the speech data by the first communication terminal device of FIG. 17;

FIG. 21 is a sequence diagram showing the steps of receiving the speech data by the second communication terminal device of FIG. 18;

FIG. 22 is a flowchart showing the steps of generating speech data by the first communication terminal device of FIG. 17;

FIG. 23 is a flowchart showing the steps of receiving the speech data by the second communication terminal device of FIG. 18; and

FIG. 24 is a sequence diagram showing the steps of transmitting the speech data by the communication system according to Embodiment 6.

### DETAILED DESCRIPTION

The invention will now be described by reference to the preferred embodiments. This does not intend to limit the scope of the present invention, but to exemplify the invention.

### Embodiment 1

A brief summary will be given before describing the invention in specific details. Embodiment 1 relates to a communication terminal in business wireless communication. Business wireless communication allows speech communication in a predefined wireless CH. Speech communication is exemplified by Push to Talk (PTT). In PTT, the user pushes a button during a conversation and releases the button when the conversation is terminated. In business wireless communication, it is possible to form a group by a plurality of communication terminal devices. A base station device in business wireless communication assigns an upstream channel and a downstream channel to a group. Once the group and the channels are set up, one communication terminal device in the group transmits a signal using the upstream channel and another communication terminal device in the group receives the signal using the downstream channel.

When the communication environment in business wireless communication is degraded, the communication quality is degraded, which makes it difficult to make a call. Considering the usage of business wireless communication, it is necessary to guarantee communication. In order to address this need, the communication terminal device according to this embodiment not only transmits speech data business wireless communication but also stores the speech data in a memory. In this process, the speech data is stored in the memory by mapping the speech data to time information. The communication terminal device at the receiving end receives and reconstructs the speech data. When the content of speech becomes unclear due to degradation in the communication quality, the communication terminal device at the receiving end transmits a request signal. The request signal includes time information for identifying a point of time when the content of speech becomes unclear. Upon receiving the request signal, the communication terminal device at the call originating end acquires the speech data from the memory based on the time information included in the request signal and transmits the acquired speech data. Since the speech data that should be retrieved from the memory is identified based on the time information, it is not necessary to transmit the entirety of the speech data stored in the memory so that the efficiency of transmission is improved.

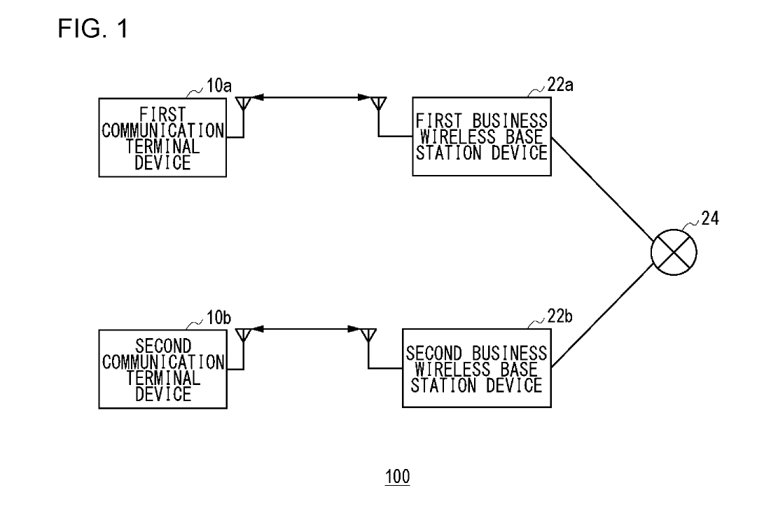

FIG. 1 shows a configuration of a communication system 100 according to Embodiment 1. The communication system 100 includes a first communication terminal device 10a, a second communication terminal device 10b, which are generically referred to as communication terminal devices 10, a first business wireless base station device 22a, a second business wireless base station device 22b, which are generically referred to as business wireless base station devices 22, and a network 24. The communication terminal device 10 is capable of communicating using business wireless communication. A publicly known technology may be used for business wireless communication so that a description thereof is omitted. The first communication terminal device 10a is described here as originating speech communication using business wireless communication and the second communication terminal device 10b is described as receiving speech communication using business wireless communication. However, the relationship may be inverted.

The business wireless base station devices 22 are base station devices compatible with business wireless systems. Each of the business wireless base station devices 22 is connected at one end with the communication terminal device 10 using business wireless communication and at the other end with a network 24. The first business wireless base station device 22a and the second business wireless base station device 22b are provided at different locations. The network 24 connects the first business wireless base station device 22a and the second business wireless base station device 22b. Through this connection, the first communication terminal device 10a and the second communication terminal device 10b are capable of communicating with each other via the first business wireless base station device 22a, the network 24, and the second business wireless base station device 22b.

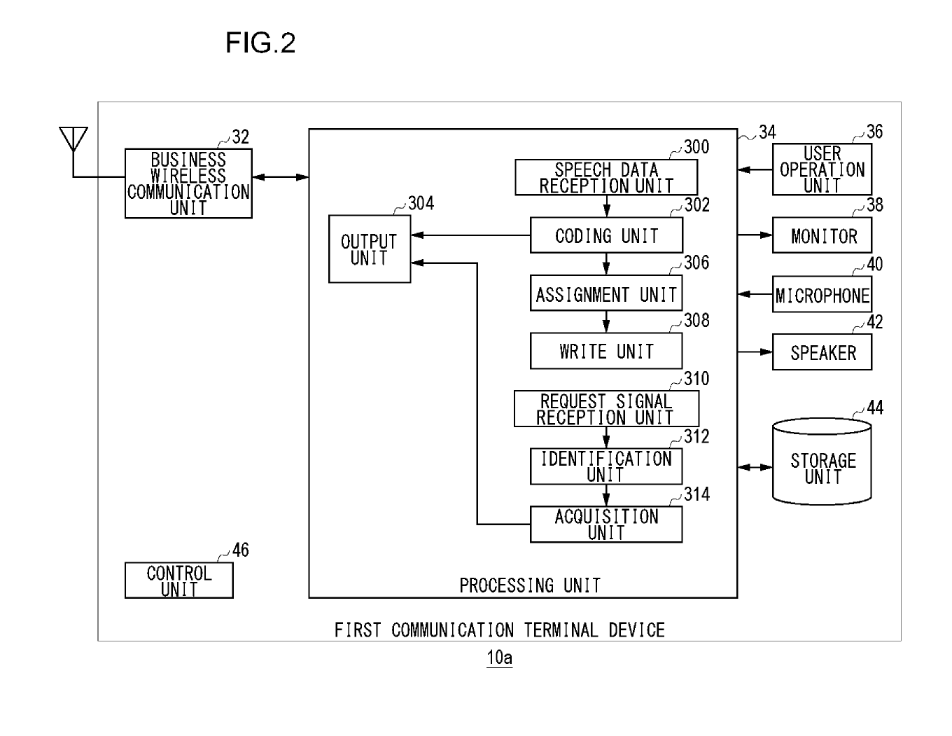

FIG. 2 shows the features of the first communication terminal device 10a. The first communication terminal device 10a includes a business wireless communication unit 32, a processing unit 34, a user operation unit 36, a monitor 38, a microphone 40, a speaker 42, a storage unit 44, and a control unit 46. The processing unit 34 includes a speech data reception unit 300, a coding unit 302, an output unit 304, an assignment unit 306, a write unit 308, a request signal reception unit 310, an identification unit 312, and an acquisition unit 314. The first communication terminal device 10a originates a call using business wireless communication.

The business wireless communication unit 32 performs communication with the business wireless base station device 22 using business wireless communication. The business wireless communication unit 32 also performs speech communication with the other communication terminal device 10 via the business wireless base station device 22. The business wireless communication unit 32 in the communication terminal device 10 is identified by, for example, a wireless CH. The processing unit 34 controls communication by the business wireless communication unit 32. Particularly, the processing unit 34 carries out a call process in business wireless communication. The processing unit 34 performs processes in coordination with the second communication terminal device 10b described later and so will be described later along with those processes.

The user operation unit 36 is formed by a button, a touch panel, etc. and receives an input from the user. The user operation unit 36 outputs the received input to the processing unit 34. The monitor 38 receives and displays images, moving images, messages from the processing unit 34. If the screen is a touch panel, the monitor 38 is integrated with the user operation unit 36. The microphone 40 receives a speech from the user at the time of a call and converts the speech into a speech signal. The microphone 40 outputs the speech signal to the processing unit 34. The speaker 42 receives the speech signal from the processing unit 34 at the time of a call and outputs the speech signal as a speech. The speaker 42 may output an alert sound, etc. The storage unit 44 stores speech data, information related to the speech data, etc. The information related to the speech data will be described later. Writing in the storage unit 44 and reading from the storage unit 44 are performed by the processing unit 34. The control unit 46 controls the operation of the first communication terminal device 10a.

The features are implemented in hardware such as a CPU, a memory, or other LSI's of an arbitrary computer, and in software such as a program loaded into a memory, etc. The figure depicts functional blocks implemented by the cooperation of these elements. Therefore, it will be obvious to those skilled in the art that the functional blocks may be implemented in a variety of manners by hardware only, by software only, or by a combination of hardware and software.

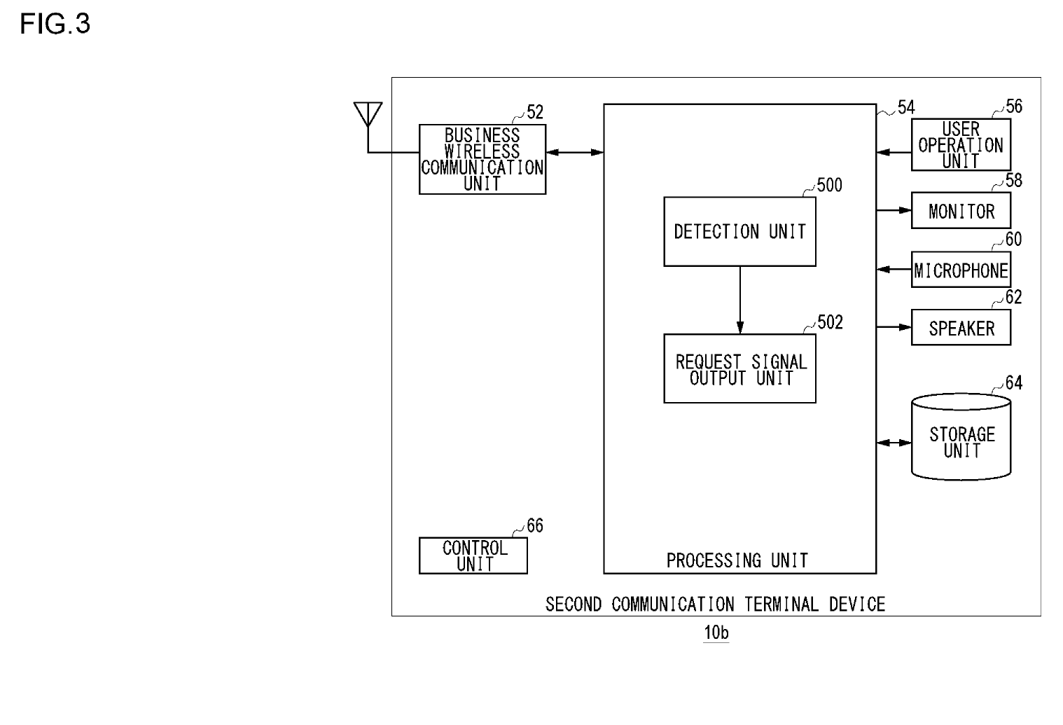

FIG. 3 shows the features of the second communication terminal device 10b. The second communication terminal device 10b includes a business wireless communication unit 52, a processing unit 54, a user operation unit 56, a monitor 58, a microphone 60, a speaker 62, a storage unit 64, and a control unit 66. The processing unit 54 includes a detection unit 500 and a request signal output unit 502. The second communication terminal device 10b processes an incoming call in business wireless communication. The business wireless communication unit 52 through the control unit 66 are the same as the business wireless communication unit 32 through the control unit 46 of FIG. 2 so that a description thereof is omitted. Like the processing unit 34 described above, the processing unit 54 performs processes in coordination with the first communication terminal device 10a and so will be described later along with those processes.

A description will be given of processes in the processing unit 34 in the first communication terminal device 10a and the processing unit 54 in the second communication terminal device 10b. The speech data reception unit 300 of the first communication terminal device 10a receives a speech signal from the microphone 40 while the PTT button of the user operation unit 36 is being pressed. The speech signal represents speech data subject to transmission. The speech data is a digital signal. The speech data reception unit 300 outputs the received speech data to the coding unit 302. The coding unit 302 receives the speech data from the speech data reception unit 300. The coding unit 302 encodes the speech data. The coding unit 302 outputs the encoded speech data (hereinafter, also referred to as “speech data”) to the output unit 304 and the assignment unit 306. The output unit 304 of the first communication terminal device 10a receives the speech data from the coding unit 302 and causes the business wireless communication unit 32 to transmit the speech data.

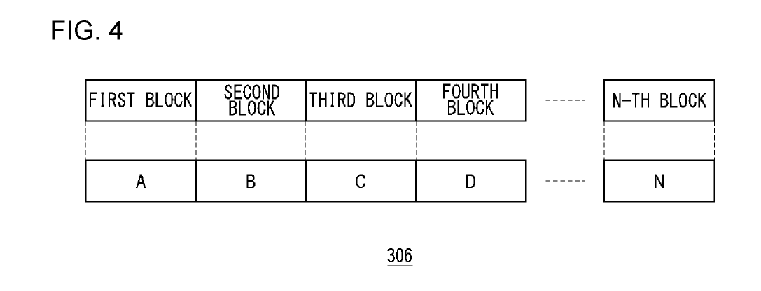

The assignment unit 306 of the first communication terminal device 10a assigns time information to the speech data received from the coding unit 302. The process in the assignment unit 306 will be described with reference to FIG. 4. FIG. 4 shows time information assigned in the assignment unit 306. The top of the figure shows speech data. The assignment unit 306 divides the speech data into plural blocks according to the elapsed time. In the illustrated example, the speech data is divided into a first block, a second block, a third block, a fourth block, and an N-th block. The first block corresponds to the portion that occurs first in time and the N-th block corresponds to the portion that occurs last in time. The assignment unit 306 generates time information “A,” “B,” “C,” “D,” and “N” for identifying the plural blocks produced by the division.

“A,” etc. denotes time. The time information corresponds to the time when the block is generated or the time when the block should be reconstructed. Each of “A,”

“B,” “C,” “D,” and “N” may be referred to as time information. Alternatively, a set of “A,” “B,” “C,” “D,” and “N” may be referred to as time information. Reference is made back to FIG. 3. The assignment unit 306 outputs the speech data to which time information is assigned to the write unit 308. The write unit 308 of the first communication terminal device 10a receives the time information and the speech data from the assignment unit 306. The write unit 308 causes the storage unit 44 to store the time information and the speech data.

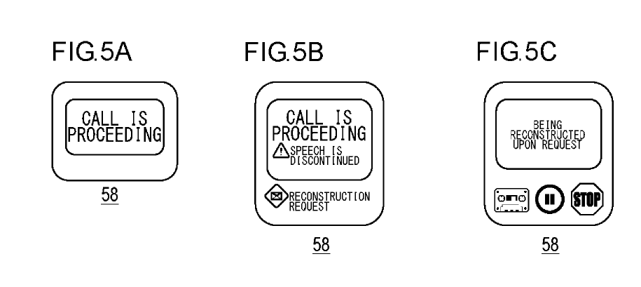

The processing unit 54 of the second communication terminal device 10b receives the speech data from the first communication terminal device 10a via the business wireless communication unit 52. The processing unit 54 decodes the received speech data and causes the speaker 62 to output the decoded speech data as a speech signal. In this state, the processing unit 54 causes the monitor 58 to display a message indicating that a call is proceeding. FIGS. 5A-5C show screens displayed on the monitor 58. FIG. 5A shows a screen showing that “a call is proceeding.” FIGS. 5B-5C will be described later. Reference is made back to FIG. 3.

The detection unit 500 of the second communication terminal device 10b detects that the quality of the speech data received in the business wireless communication unit 52 from the first communication terminal device 10a is degraded. For detection of degraded quality, a publicly known technology may be used so that a description thereof is omitted. Degraded quality means that it is difficult for the user to hear the speech output from the speaker 62.

The detection unit 500 acquires the time when the degraded quality is detected. The detection unit 500 generates time information based on the acquired time. For example, the detection unit 500 may use the acquired time directly as time information. Alternatively, time information earlier than the acquired time may be generated in consideration of the propagation delay from the first communication terminal device 10a to the second communication terminal device 10b and of the processing delay in the second communication terminal device 10b. Upon detection of degradation in quality, the detection unit 500 notifies the request signal output unit 502 of degradation in quality and outputs the generated time information to the request signal output unit 502. Further, upon detection of degradation in quality, the detection unit 500 causes the monitor 58 to display a message indicating that the quality is degraded. FIG. 5B shows a screen shown in this case and shows a screen presenting a message “speech is discontinued.” Reference is made back to FIG. 3.

When the request signal output unit 502 of the second communication terminal device 10b is notified by the detection unit 500 of degradation in quality, the request signal output unit 502 transmits a request signal to the first communication terminal device 10a via the business wireless communication unit 52. The request signal is a signal to request transmission of the speech data stored in the storage unit 44 of the first communication terminal device 10a. The request signal also includes the time information from the detection unit 500. Meanwhile, the request signal output unit 502 may transmit a request signal after receiving an instruction from the user. To describe it more specifically, if the request signal output unit 502 is notified by the detection unit 500 of degradation in quality and “a reconstruction request” shown in FIG. 5B is selected in the user operation unit 56, the request signal output unit 502 transmits a request signal.

The request signal reception unit 310 of the first communication terminal device 10a receives the request signal from the second communication terminal device 10b via the business wireless communication unit 32. The request signal reception unit 310 outputs the request signal to the identification unit 312. The identification unit 312 of the first communication terminal device 10a extracts time information included in request signal from request signal reception unit 310. The identification unit 312 outputs the time information to the acquisition unit 314. The identification unit 312 may revise the extracted time information to indicate earlier time. In that case, the identification unit 312 outputs the revised time information (hereinafter, also referred to as “time information”) to the acquisition unit 314.

When the acquisition unit 314 of the first communication terminal device 10a acquires time information from the identification unit 312, the acquisition unit 314 acquires the speech data following the block identified based on the time information from the storage unit 44. The time information may encompass time information on a start and an end. In this case, the speech data may be acquired based on the time information on the start and end. The acquisition unit 314 outputs the acquired speech signal to the output unit 304. The output unit 304 of the first communication terminal device 10a causes the business wireless communication unit 32 to transmit the speech data acquired in the acquisition unit 314.

The processing unit 54 of the second communication terminal device 10b receives the speech data from the first communication terminal device 10a via the business wireless communication unit 52. The processing unit 54 decodes the received speech data and causes the speaker 62 to output the decoded speech data as a speech signal. In this state, the processing unit 54 causes the monitor 58 to display a message showing that the speech signal is being reconstructed. FIG. 5C shows a screen shown in this case and shows a screen presenting a message “being reconstructed upon request.”

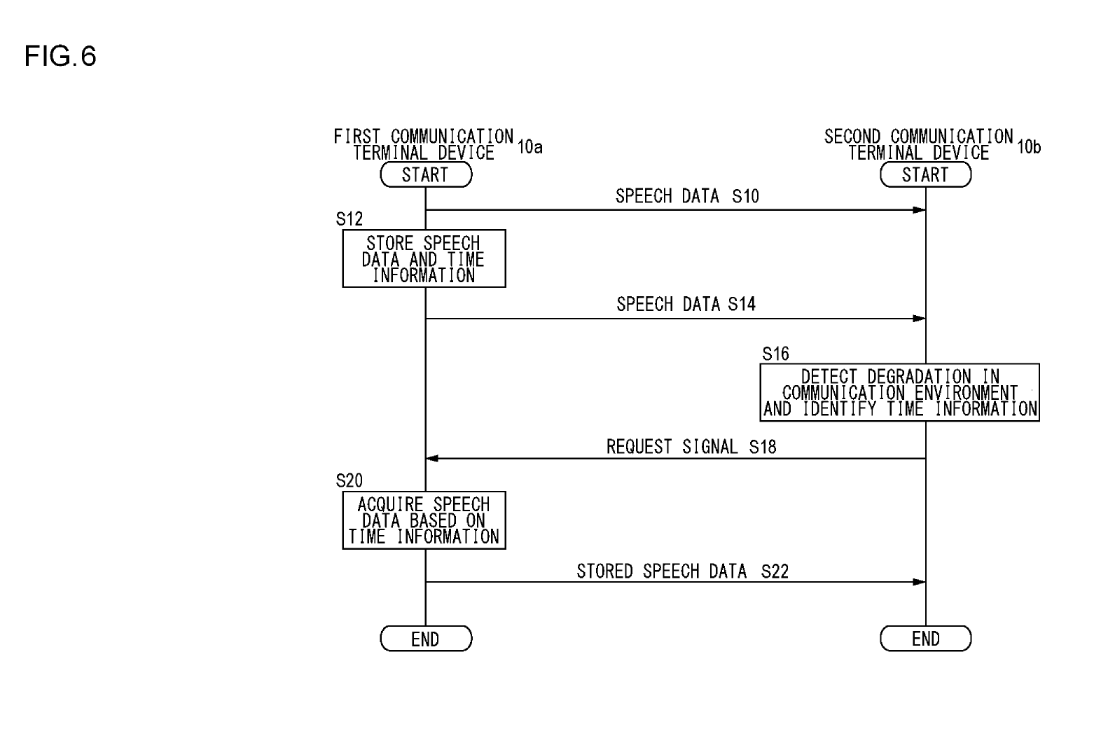

A description will be given of the operation of the communication system 100 with the above features. FIG. 6 is a sequence diagram showing the steps of transmitting the speech data by the communication system 100. The first communication terminal device 10a transmits the speech data to the second communication terminal device 10b (S10). The first communication terminal device 10a stores the speech data and the time information (S12). The first communication terminal device 10a transmits the speech data to the second communication terminal device 10b (S14). The second communication terminal device 10b detects degradation in the communication environment and identifies the time information (S16). The second communication terminal device 10b transmits a request signal to the first communication terminal device 10a (S18). The first communication terminal device 10a acquires the speech data based on the time information included in the request signal (S20). The first communication terminal device 10a transmits the stored speech data to the second communication terminal device 10b (S22).

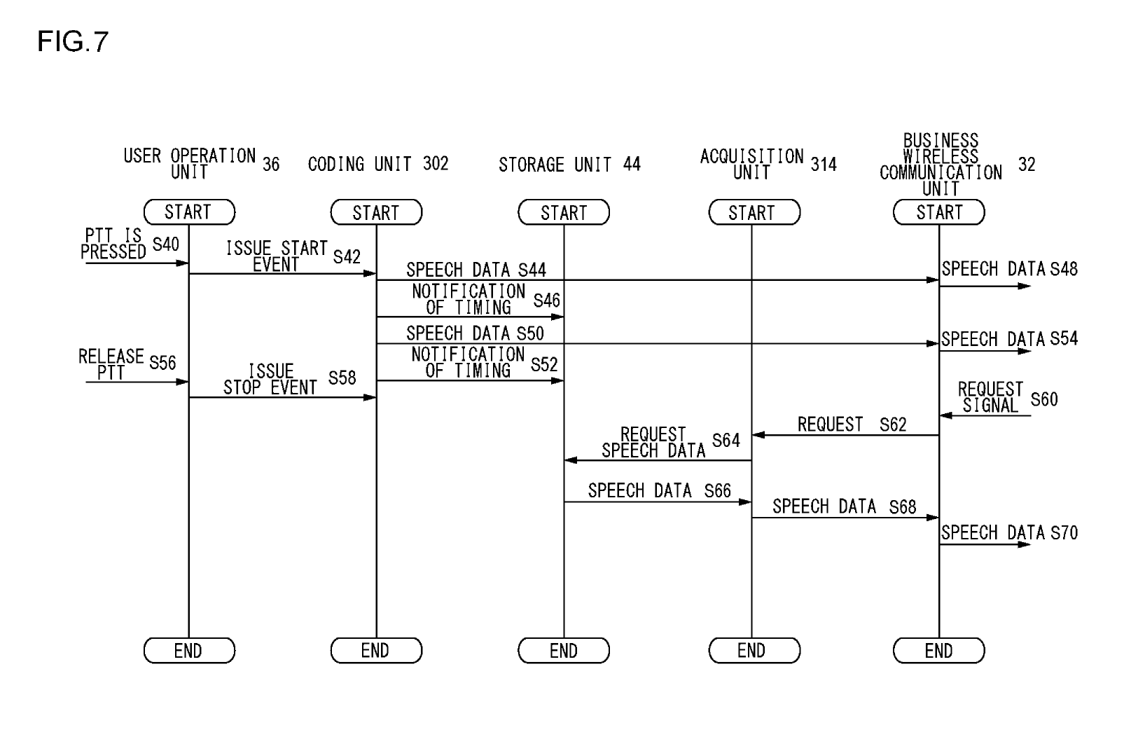

FIG. 7 is a sequence diagram showing the steps of transmitting the speech data by the first communication terminal device 10a. The user operation unit 36 receives the pressing of the PTT button (S40). The user operation unit 36 issues a start event to the coding unit 302 (S42). The coding unit 302 outputs the speech data to the business wireless communication unit 32 (S44) and notifies the storage unit 44 of the timing for storage (S46). The storage unit 44 stores the speech data accordingly. The business wireless communication unit 32 transmits the speech data (S48). The coding unit 302 outputs the speech data to the business wireless communication unit 32 (S50) and notifies the storage unit 44 of the timing for storage (S52). The business wireless communication unit 32 transmits the speech data (S54).

The user operation unit 36 receives the release of the PTT button (S56). The user operation unit 36 issues a stop event to the coding unit 302 (S58). The business wireless communication unit 32 transmits a request signal (S60). The business wireless communication unit 32 outputs the request to the acquisition unit 314 (S62). The acquisition unit 314 requests the storage unit 44 for the speech data (S64) and acquires the speech data from the storage unit 44 (S66). The acquisition unit 314 outputs the speech data to the business wireless communication unit 32 (S68). The business wireless communication unit 32 transmits the speech data (S70).

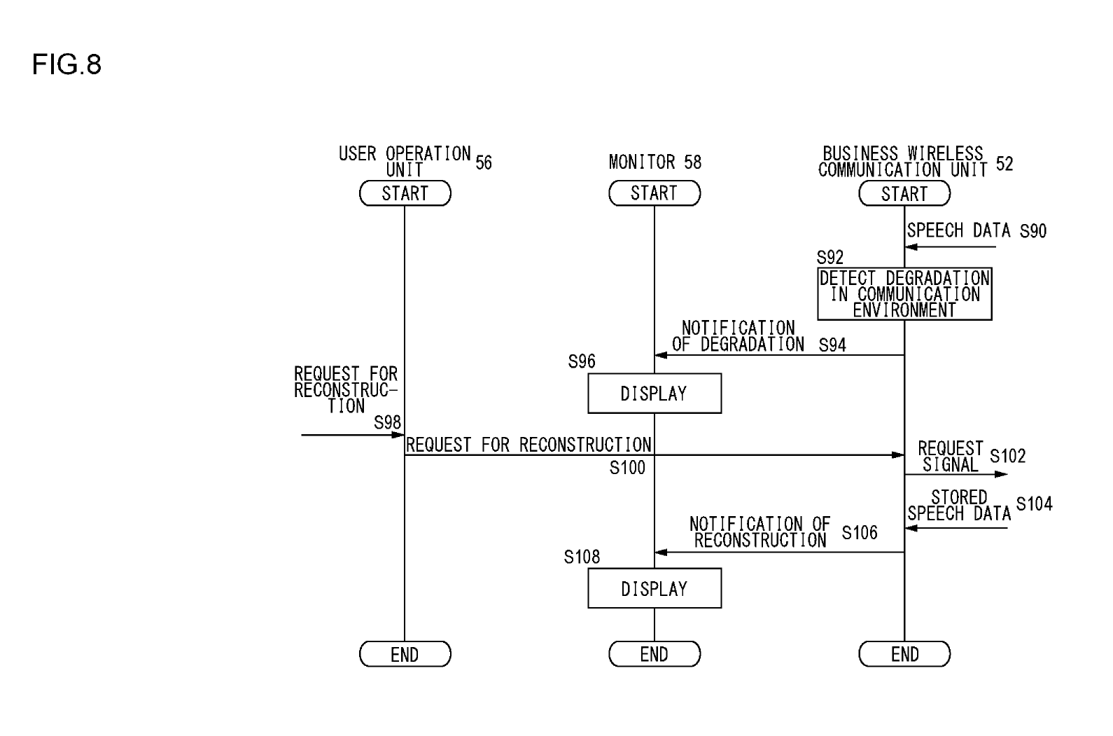

FIG. 8 is a sequence diagram showing the steps of receiving the speech data by the second communication terminal device 10b. The business wireless communication unit 52 receives the speech data (S90). The speech data received in the business wireless communication unit 52 is examined to detect degradation in the communication environment (S92). When degradation is detected, the monitor 58 is notified of degradation (S94). The monitor 58 displays the degradation (S96). A request for reconstruction is entered in the user operation unit 56 (S98). The user operation unit 56 outputs the request for reconstruction to the business wireless communication unit 52 (S100) and the business wireless communication unit 52 transmits a request signal (S102). The business wireless communication unit 52 receives the stored speech data (S104). The business wireless communication unit 52 outputs a notification of reconstruction to the monitor 58 (S106) and the monitor 58 displays that the speech data is being reconstructed (S108).

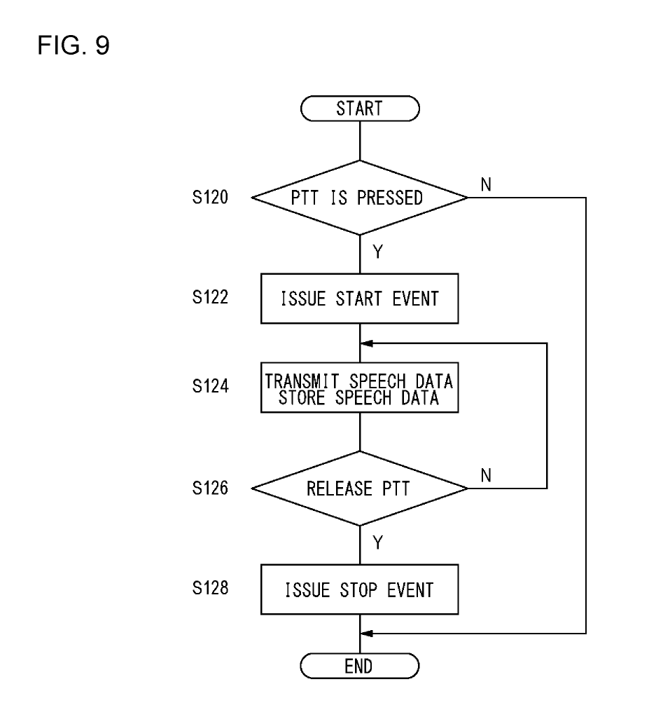

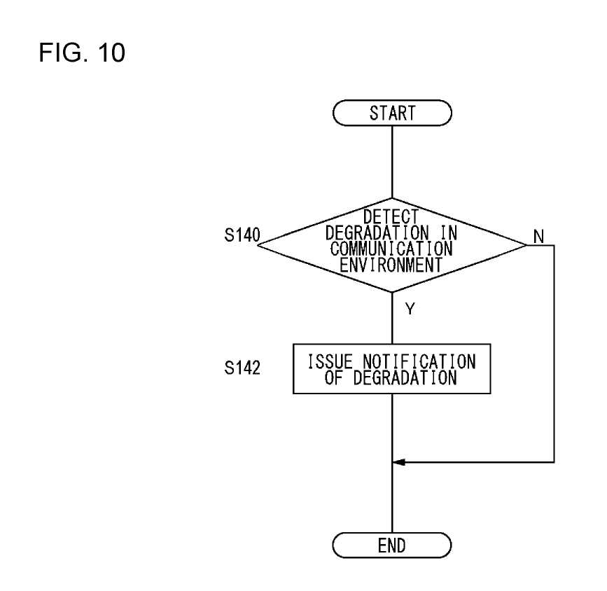

FIG. 9 is a flowchart showing the steps of generating speech data by the first communication terminal device 10a. When the user operation unit 36 receives the pressing of the PTT button (Y in S120), a start event is issued (S122). The output unit 304 causes the business wireless communication unit 32 to transmit the speech data and the write unit 308 causes the storage unit 44 to store the speech data (S124). When the user operation unit does not receive the release of the PTT button (N in S126), control is returned to step 124. When the user operation unit 36 receives the release of the PTT button (Y in S126), a stop event is issued (S128). When the user operation unit 36 does not receive the pressing of the PTT button (N in S120), step 122 through step 128 are skipped.

FIG. 10 is a flowchart showing the steps of detecting degradation in the communication environment by the second communication terminal device 10b. When the detection unit 500 detects degradation in the communication environment (Y in S140), a notification of degradation is issued (S142). When the detection unit 500 does not detect degradation in the communication environment (N in S140), step 142 is skipped.

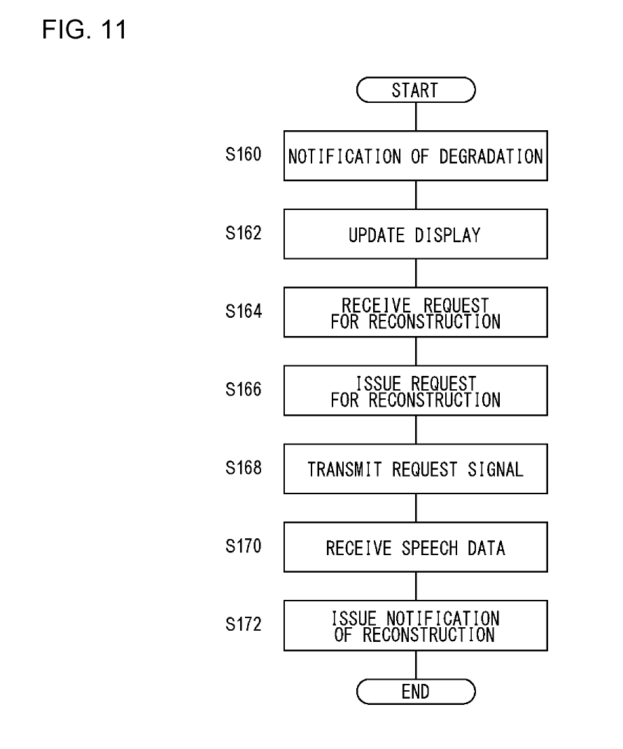

FIG. 11 is a flowchart showing the steps of receiving the speech data by the second communication terminal device 10b. A notification of degradation is issued (S160). The monitor 58 updates the display (S162). When the user operation unit 56 receives the request for reconstruction (S164), a reconstruction request is issued (S166). The business wireless communication unit 52 transmits a request signal (S168). When the business wireless communication unit 52 receives the speech data (S170), a notification of reconstruction is issued (S172).

According to this embodiment, the speech data is stored along with the time information, and the speech data is acquired based on the time information included in the request signal received. Therefore, the speech data needed can be transmitted efficiently. Since the speech data is identified based on the time information, two communication terminal devices can use the common timing. Since the stored speech data is identified based on the time information, the content of speech data can be checked even if it is difficult to communicate speech data. Since the transmission of stored speech data is requested, important information can be retrieved exhaustively for reconstruction even if the communication environment is degraded.

### Embodiment 2

A description will now be given of Embodiment 2. Like Embodiment 1, Embodiment 2 also relates to the communication terminal device in business wireless communication. In Embodiment 1, the time information is used to identify the elapsed time of the speech data. Meanwhile, numbering information is used to identify the elapsed time of the speech data in Embodiment 2. The numbering information is information generated in increments by 1 at predetermined intervals. The communication system and the second communication terminal device 10b according to Embodiment 2 are of the same type as shown in FIGS. 1 and 3. The following description concerns a difference from the embodiments described above.

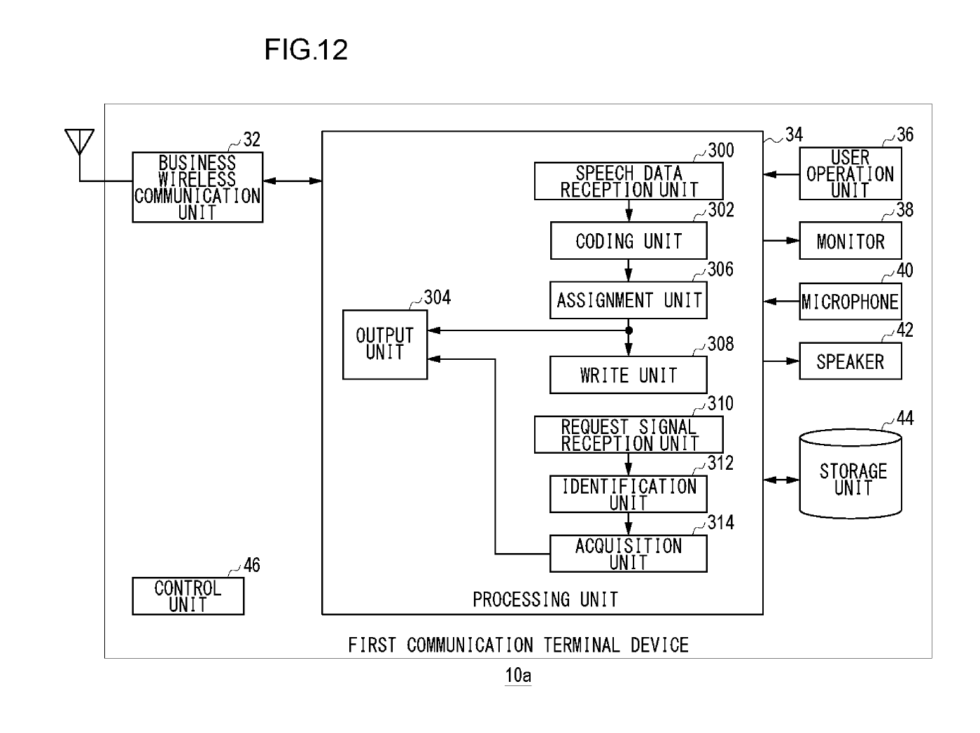

FIG. 12 shows the features of the first communication terminal device 10a according to Embodiment 2. The components included in the processing unit 34 are the same as those of FIG. 2, but the relation of connection between the components is different from that of FIG. 2. The business wireless communication unit 32 through the control unit 46 are as shown in FIG. 2 so that a description thereof is omitted. A description will be given of processes in the processing unit 34 in the first communication terminal device 10a and the processing unit 54 in the second communication terminal device 10b.

The coding unit 302 outputs the encoded speech data (hereinafter, also referred to as “speech data”) to the assignment unit 306. The assignment unit 306 of the first communication terminal device 10a assigns numbering information to the speech data received from the coding unit 302. As in Embodiment 1, the assignment unit 306 divides the speech data into plural blocks according to the elapsed time. Further, the assignment unit 306 generates numbering information for identifying each of the plural blocks produced by the division. To describe it more specifically, the assignment unit 306 generates numbering information for the plural blocks arranged according to the elapsed time such that the numbering is incremented by “1” when control is shifted from the previous block to the subsequent block. In other words, blocks later in the time sequence are numbered with larger values. The assignment unit 306 outputs the speech data to which time information is assigned to the output unit 304 and the write unit 308.

The output unit 304 of the first communication terminal device 10a receives the numbering information and the speech data from the assignment unit 306 and causes the business wireless communication unit 32 to transmit the numbering information and the speech data. The write unit 308 of the first communication terminal device 10a receives the numbering information and the speech data from the assignment unit 306. The write unit 308 causes the storage unit 44 to store the numbering information and the speech data.

The processing unit 54 of the second communication terminal device 10b receives the speech data and the numbering information from the first communication terminal device 10a via the business wireless communication unit 52. The processing unit 54 decodes the received speech data and causes the speaker 62 to output the decoded speech data as a speech signal.

The detection unit 500 of the second communication terminal device 10b detects that the quality of the speech data received in the business wireless communication unit 52 from the first communication terminal device 10a is degraded. The detection unit 500 identifies the numbering information that occurs when degradation in quality is detected. Instead of the identification, the numbering information may be derived by adding a value “1” or larger to the numbering information preceding the detection of degradation in quality. Further, the detection unit 500 may subtract a certain value from the numbering information in consideration of the propagation delay from the first communication terminal device 10a to the second communication terminal device 10b and of the processing delay in the second communication terminal device 10b. Upon detection of degradation in quality, the detection unit 500 notifies the request signal output unit 502 of degradation in quality and outputs the numbering information to the request signal output unit 502.

When the request signal output unit 502 of the second communication terminal device 10b is notified by the detection unit 500 of degradation in quality, the request signal output unit 502 transmits a request signal to the first communication terminal device 10a via the business wireless communication unit 52. The request signal includes the numbering information from the detection unit 500.

The request signal reception unit 310 of the first communication terminal device 10a receives the request signal from the second communication terminal device 10b via the business wireless communication unit 32 and outputs the request signal to the identification unit 312. The identification unit 312 of the first communication terminal device 10a extracts the numbering information included in request signal from the request signal reception unit 310 and outputs the numbering information to the acquisition unit 314. When the acquisition unit 314 of the first communication terminal device 10a acquires the numbering information from the identification unit 312, the acquisition unit 314 acquires the speech data following the block identified based on time numbering information from the storage unit 44. The acquisition unit 314 outputs the acquired speech signal to the output unit 304.

According to this embodiment, the speech data is stored along with the numbering information, and the speech data is acquired based on the numbering information included in the request signal received. Therefore, the speech data needed can be transmitted efficiently. Since the speech data is identified based on the numbering information, two communication terminal devices can use the common timing. Since the stored speech data is identified based on the numbering information, the content of speech data can be checked even if it is difficult to communicate speech data. Numbering information is generated in place of time information so that the flexibility of information for identifying a block forming the speech data can be improved.

### Embodiment 3

A description will now be given of Embodiment 3. Like the foregoing embodiments, Embodiment 3 also relates to the communication terminal device in business wireless communication. The first communication terminal device according to the foregoing embodiments not only transmits speech data but also stores the speech data in the storage unit. Meanwhile, the first communication terminal device according to Embodiment 3 stores the speech data in the storage unit after detecting degradation in the communication environment. Thus, the first communication terminal device stores the speech data for a period of time in which the communication environment for business wireless communication is degraded. When the communication environment is restored and the request signal from the second communication terminal device is received, the first communication terminal device transmits the stored content of call using business wireless communication. The communication system and the second communication terminal device according to Embodiment 3 are of the same type as shown in FIGS. 1 and 3. The following description concerns a difference from the embodiments described above.

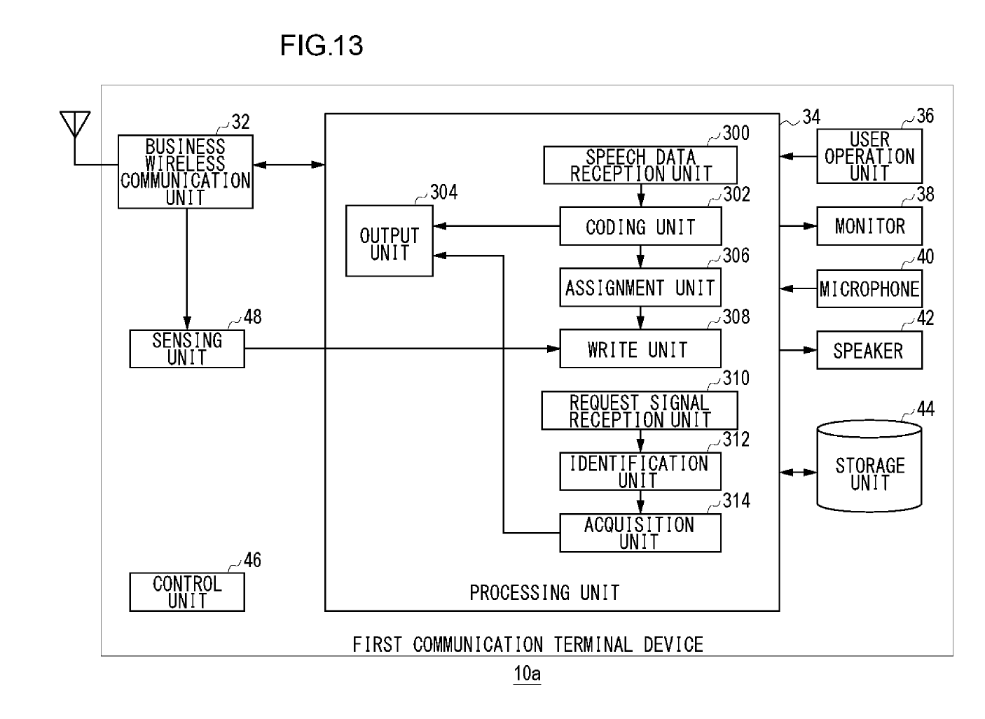

FIG. 13 shows the features of the first communication terminal device 10a according to Embodiment 3. The first communication terminal device 10a includes a business wireless communication unit 32, a processing unit 34, a user operation unit 36, a monitor 38, a microphone 40, a speaker 42, a storage unit 44, a control unit 46, and a sensing unit 48. The business wireless communication unit 32 through the control unit 46 are as shown in FIG. 2 so that a description thereof is omitted. A description will be given of processes in the processing unit 34 in the first communication terminal device 10a and the processing unit 54 in the second communication terminal device 10b.

The sensing unit 48 of the first communication terminal device 10a is connected to the business wireless communication unit 32 and measures the quality of the signal (e.g., speech data) received in the business wireless communication unit 32. For measurement of the quality, a publicly known technology may be used. For example, the quality is measured as in the detection unit 500. The sensing unit 48 identifies degradation in the communication environment used in the business wireless communication unit 32 by sensing that the measured quality is poorer than a threshold value. Upon detecting degradation in the communication environment, the sensing unit 48 notifies the write unit 308 of degradation. Further, when the degraded communication environment is improved, the sensing unit 48 notifies the write unit 308 of improvement. By communicating degradation and improvement, the write unit 308 is notified of the period of time in which degradation occurs.

Upon being notified by the sensing unit 48, i.e., when the sensing unit 48 detects degradation in the communication environment, the write unit 308 of the first communication terminal device 10a starts storing the time information and the speech data in the storage unit 44. When receiving improvement from the sensing unit 48, i.e., when the sensing unit 48 detects improvement in the communication environment, the write unit 308 stops the storage of the time information and the speech data in the storage unit 44. As a result, the write unit 308 stores the time information and the speech data in the storage unit 44 over the period of time of degradation. The numbering information may be stored in the storage unit 44 instead of the time information. The time information or numbering information may not be stored in the storage unit 44. The subsequent processes in the first communication terminal device 10a and the second communication terminal device 10b are as described in the foregoing embodiments.

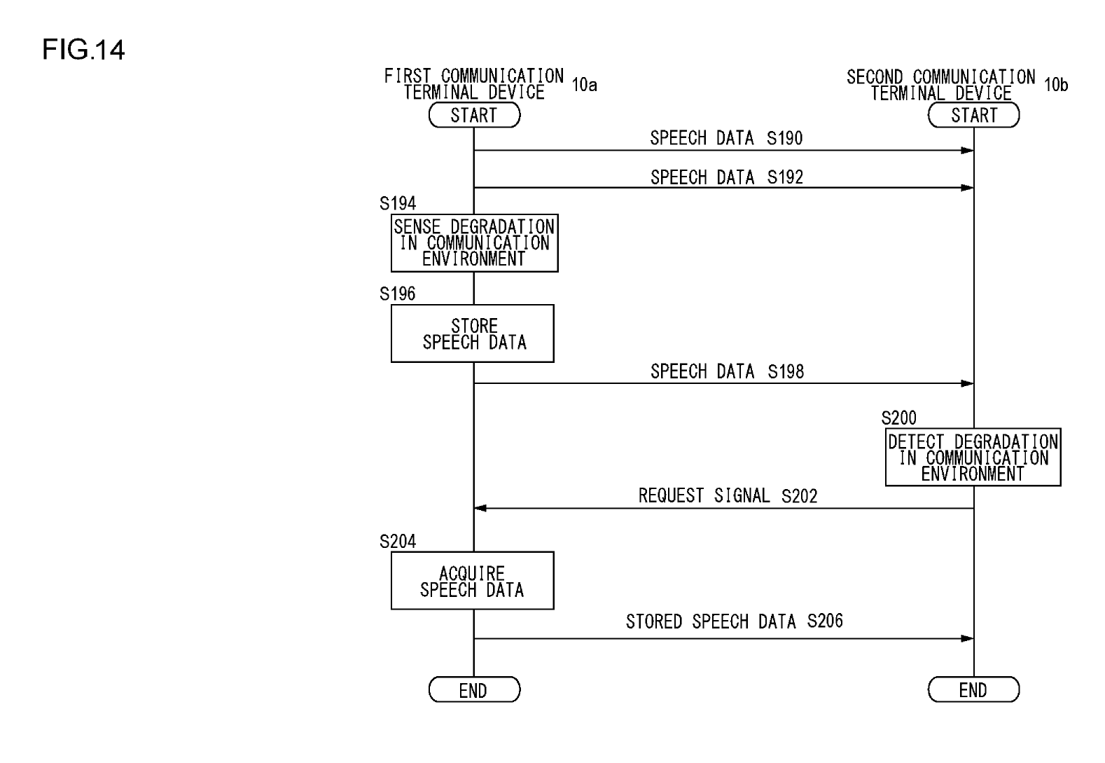

FIG. 14 is a sequence diagram showing the steps of transmitting the speech data by the communication system 100 according to Embodiment 3. The first communication terminal device 10a transmits the speech data to the second communication terminal device 10b (S190, S192). The first communication terminal device 10a detects degradation in the communication environment (S194). The first communication terminal device 10a stores the speech data (S196). The first communication terminal device 10a transmits the speech data to the second communication terminal device 10b (S198). The second communication terminal device 10b senses degradation in the communication environment (S200). The second communication terminal device 10b transmits a request signal to the first communication terminal device 10a (S202). The first communication terminal device 10a acquires the speech data (S204). The first communication terminal device 10a transmits the stored speech data to the second communication terminal device 10b (S206).

According to this embodiment, the speech data is stored when the communication environment is degraded. Therefore, the speech data likely to be required to be transmitted later can be stored. Since the speech data likely to be required to be transmitted later is stored, the speech data can be stored efficiently. Since the speech data is stored efficiently, the storage volume required in the storage unit can be reduced.

### Embodiment 4

Next Embodiment 4 will be described. Like Embodiment 1, Embodiment 4 also relates to the communication terminal device in business wireless communication, but the communication terminal device according to Embodiment 4 also performs wireless communication other than business wireless communication. The other wireless communication is mobile communication, which is IP communication exemplified by Long Term Evolution (LTE), Wireless Fidelity (WiFi) (registered trademark), etc. Other than these, mobile communication may comprise wireless Metropolitan Area Network (MAN) such as Worldwide Interoperability for Microwave Access (WiMAX). Transmission Control Protocol (TCP)/IP and layers above or below are used for communication. In mobile communication, speech communication and data communication are performed.

The communication terminal device according to this Embodiment transmits the received speech data using business wireless communication. Meanwhile, the communication terminal device transmits the speech data acquired from the storage unit using mobile communication. Transmission of the speech data acquired from the storage unit occurs when the communication environment in business wireless communication is degraded. Since the speech data acquired from the storage unit is transmitted using mobile communication, the likelihood that the speech data is accurately transmitted is improved.

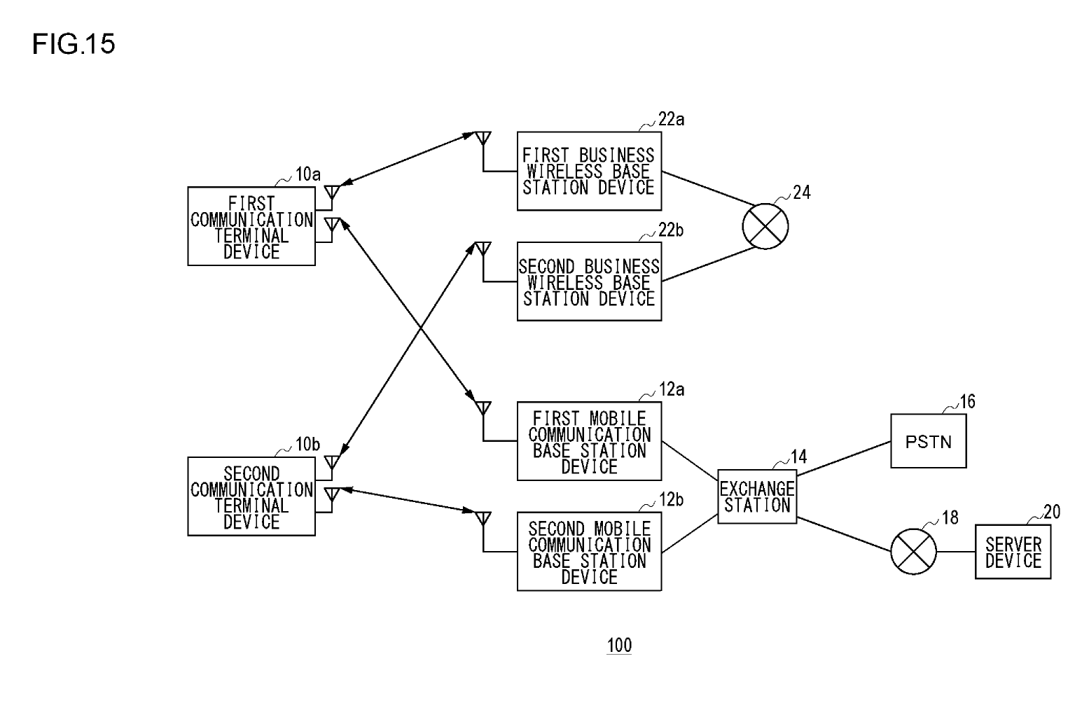

FIG. 15 shows the features of the communication system 100 according to Embodiment 4. The communication system 100 includes a first communication terminal device 10a, a second communication terminal device 10b, which are generically referred to as communication terminal devices 10, a first mobile communication base station device 12a, a second mobile communication base station device 12b, which are generically referred to as mobile communication base station devices 12, an exchange station 14, a Public Switched Telephone Network (PSTN) 16, Internet 18, a server device 20, a first business wireless base station device 22a, a second business wireless base station device 22b, which are generically referred to as business wireless base station devices 22 and a network 24.

The communication terminal device 10 is capable of communicating using mobile communication and business wireless communication. A publicly known technology may be used for mobile communication so that a description thereof is omitted. The mobile communication base station devices 12 are base station devices compatible with mobile communication systems. Each of the mobile communication base station devices 12 is connected at one end with the communication terminal device 10 and at the other end with the exchange station 14 using mobile communication. The first mobile communication base station device 12a and the second mobile communication base station device 12b are provided at different locations. The exchange station 14 controls mobile communication. The exchange station 14 is also connected to the PSTN 16 and the Internet 18. Under the control of the exchange station 14, the first communication terminal device 10a and the second communication terminal device 10b are capable of communicating with each other via the first mobile communication base station device 12a, the exchange station 14, and the second mobile communication base station device 12b. The communication terminal devices 10 are also capable of communicating with the PSTN 16 and the Internet 18 via the mobile communication base station devices 12 and the exchange station 14.

The PSTN 16 is a telephone subscriber line network and performs speech communication using a circuit switched system. The Internet 18 primarily performs data communication using IP communication. The server device 20 is connected to the Internet 18 and communicates with the communication terminal devices 10 via the Internet 18, the exchange station 14, and the mobile communication base station devices 12. The communication terminal devices 10 are capable of accessing the server device 20 via the mobile communication base station devices 12, the exchange station 14, and the Internet 18.

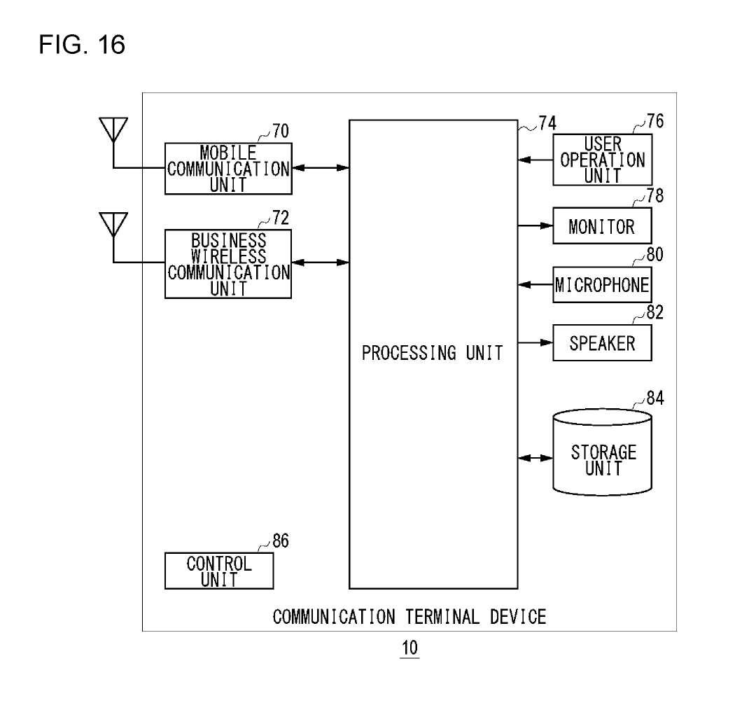

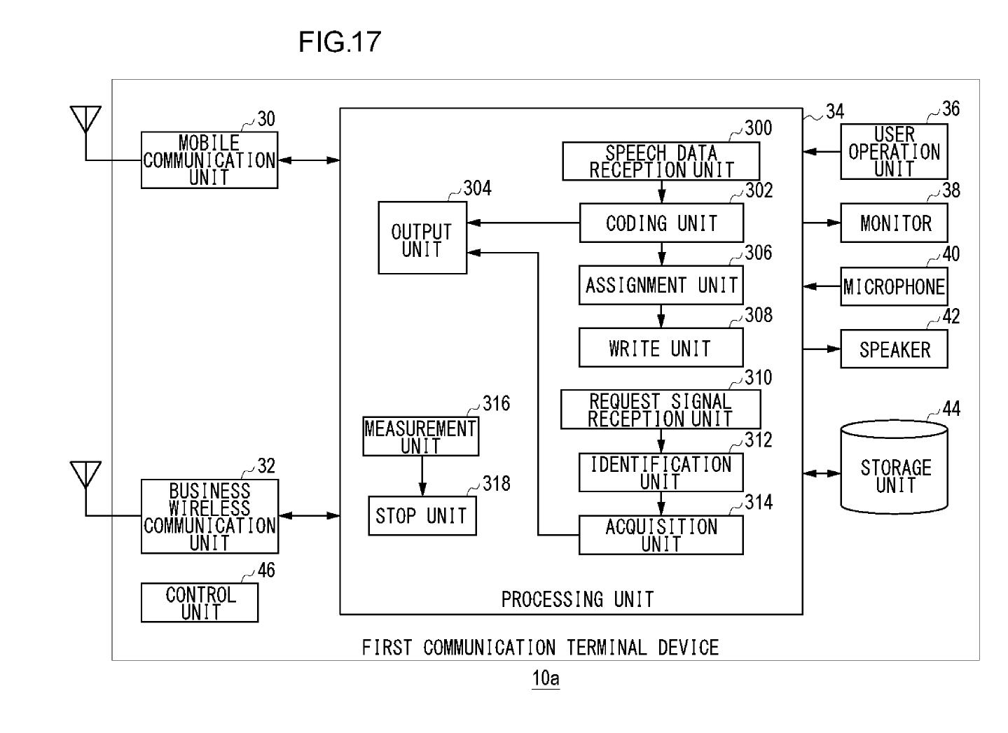

FIG. 16 shows the features of the communication terminal device 10. The communication terminal device 10 includes a mobile communication unit 70, a business wireless communication unit 72, a processing unit 74, a user operation unit 76, a monitor 78, a microphone 80, a speaker 82, a storage unit 84, and a control unit 86. The business wireless communication unit 72 through the control unit 86 correspond to the business wireless communication unit 32 through the control unit 46 of FIG. 2, and the business wireless communication unit 52 through the control unit 66 of FIG. 3. In other words, FIG. 16 the features inclusive of the function of the transmitting end and the function of the receiving end.

The mobile communication unit 70 performs mobile communication with the mobile communication base station device 12. The mobile communication unit 70 communicates with the other communication terminal device 10, the PSTN 16, the Internet 18, and the server device 20 via the mobile communication base station devices 12 and the exchange station 14. The mobile communication unit 70 in the communication terminal device 10 is identified by, for example, an IP address. Given that mobile communication in the mobile communication unit 70 is referred to as the first communication scheme, business wireless communication in the business wireless communication unit 72 is referred to as the second communication scheme.

The processing unit 74 performs a transmission process similar to that of the processing unit 34 of FIG. 2 and performs a reception process similar to that of the processing unit 54 of FIG. 3. In the transmission process, the processing unit 74 uses the business wireless communication unit 72 to transmit the received speech data. Further, the processing unit 74 uses the mobile communication unit 70 to receive a request signal. Still further, the processing unit 74 uses the mobile communication unit 70 to transmit the speech data acquired from the storage unit 84. In the reception process, the processing unit 74 uses the business wireless communication unit 72 to receive the received speech data. Further, the processing unit 74 uses the mobile communication unit 70 to transmit a request signal. Still further, the processing unit uses the mobile communication unit 70 to receive the speech data acquired from the storage unit 84.

According to this embodiment, the received speech data is transmitted using business wireless communication and the speech data acquired from the storage unit is transmitted using mobile communication so that the likelihood of transmitting the acquired speech data accurately can be improved.

### Embodiment 5

A description will now be given of Embodiment 5. Like Embodiment 4, Embodiment 5 also relates to a communication system compatible with two communication schemes, i.e., business wireless communication and mobile communication. In Embodiment 4, business wireless communication and mobile communication are used switchably depending on the communication environment. Meanwhile, Embodiment 5 uses business wireless communication and mobile communication switchably depending on the remaining life of the battery driving the first communication terminal device. An assumption for this is that the transmission power in mobile communication is smaller than the transmission power in business wireless communication. When the battery life goes low while speech data is being transmitted using business wireless communication, transmission using business wireless communication will be disabled. Embodiment 4 is directed to transmitting speech data even in this case. The communication system according to Embodiment 5 is of the same type as that of FIG. 15. The following description concerns a difference from the embodiments described above.

FIG. 17 shows the features of the first communication terminal device 10a according to Embodiment 5. The first communication terminal device 10a includes a mobile communication unit 30, a business wireless communication unit 32, a processing unit 34, a user operation unit 36, a monitor 38, a microphone 40, a speaker 42, a storage unit 44, and a control unit 46. In addition to the features of the processing unit 34 of FIG. 2, the processing unit 34 further includes a measurement unit 316 and a stop unit 318. The mobile communication unit 30 is the same as the mobile communication unit 70 of FIG. 16 and the business wireless communication unit 32 through the control unit 46 are as shown in FIG. 2 so that a description thereof is omitted. The processing unit 34 performs processes in coordination with the second communication terminal device 10b and so will be described later along with those processes.

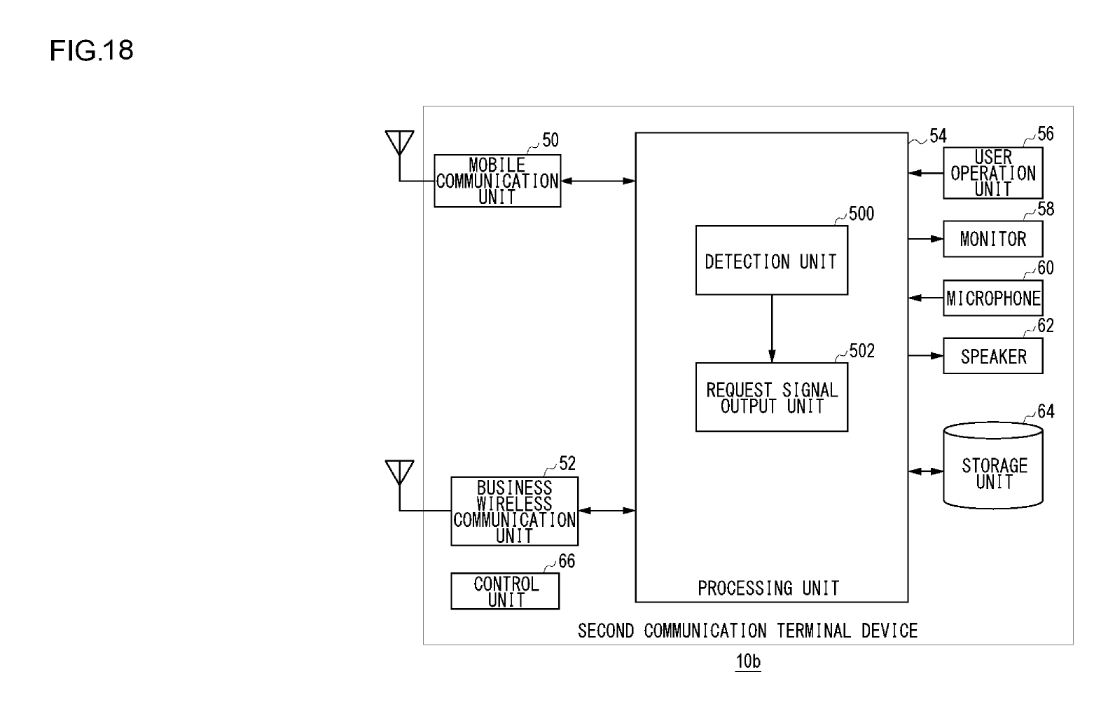

FIG. 18 shows the features of the second communication terminal device 10b according to Embodiment 5. The second communication terminal device 10b includes a mobile communication unit 50, a business wireless communication unit 52, a processing unit 54, a user operation unit 56, a monitor 58, a microphone 60, a speaker 62, a storage unit 64, and a control unit 66. The processing unit 54 is configured as shown in FIG. 3. The mobile communication unit 50 is the same as the mobile communication unit 70 of FIG. 16 and the business wireless communication unit 52 through the control unit 66 are as shown in FIG. 3 so that a description thereof is omitted. The processing unit 54 performs processes in coordination with the first communication terminal device 10a and so will be described later along with those processes.

A description will be given of processes in the processing unit 34 in the first communication terminal device 10a and the processing unit 54 in the second communication terminal device 10b. The output unit 304 of the first communication terminal device 10a receives the speech data from the coding unit 302 and causes the business wireless communication unit 32 to transmit the speech data. Therefore, the speech data is transmitted using business wireless communication. The write unit 308 of the first communication terminal device 10a receives the time information and the speech data from the assignment unit 306 and causes the storage unit 44 to store the time information and the speech data. If the assignment unit 306 generates numbering information instead of time information, the write unit 308 receives the numbering information and the speech data and causes the storage unit 44 to store the numbering information and the speech data. The output unit 304 causes the business wireless communication unit 32 to transmit the numbering information and the speech data. The time information and the numbering information may not be generated by omitting the assignment unit 306. In that case, the write unit 308 causes the storage unit 44 to store the speech data and the output unit 304 causes the business wireless communication unit 32 to transmit the speech data.

The measurement unit 316 of the first communication terminal device 10a measures the remaining life of the battery (not shown) driving the first communication terminal device 10a. A publicly known technology may be used to measure the remaining life so that a description thereof is omitted. When the remaining life measured is equal to or higher than a threshold value, a notification of completion of coding is output from the coding unit 302 once a predetermined volume of speech data has been encoded in the coding unit 302, and the encoded speech data is output to the business wireless communication unit 32. When the remaining life goes lower than the threshold value, the measurement unit 316 causes the monitor 38 to display that the remaining life is low. In this way, the user is notified that the remaining life of the battery is low.

Further, the measurement unit 316 notifies the stop unit 318 that the remaining life is low when the remaining life goes lower than the threshold value. When the stop unit 318 of the first communication terminal device 10a receives the notification from the measurement unit 316, the stop unit 318 causes the business wireless communication unit 32 to stop the transmission of the speech data. As a result, the business wireless communication unit 32 stops the transmission of the speech data using business wireless communication.

The processing unit 54 of the second communication terminal device 10b receives the speech data from the first communication terminal device 10a via the business wireless communication unit 52 using business wireless communication. When the reception of the speech data is started, the processing unit 54 outputs a speech reception start notification to the detection unit 500. Further, the processing unit 54 receives an end-of-call notification from the first communication terminal device 10a via the business wireless communication unit 52 and outputs the end-of-call notification to the detection unit 500.

Upon receiving the speech reception start notification, the detection unit 500 of the second communication terminal device 10b starts an end-of-call wait timer. Normally, a speech reception process is performed between the output of the speech reception start notification and the output of the end-of-call notification. If the first communication terminal device 10a stops the transmission, the second communication terminal device 10b may not receive the end-of-call notification. In this case, the second communication terminal device 10b will not be able to identify a condition to stop the speech reception process. In order to detect this situation, the end-of-call wait timer is used. The end-of-call wait timer increments the count with time and resets the count each time the speech data is received. Therefore, the count is increased while the absence of reception of speech data continues. When a predefined value is exceeded, a time over occurs. When the detection unit 500 detects a time over of the end-of-call wait timer, i.e., when the period of time in which the speech data is not received is longer that a predetermined period of time, the detection unit 500 notifies the request signal output unit 502 accordingly.

When the request signal output unit 502 of the second communication terminal device 10b is notified by the detection unit 500 of a time over, the request signal output unit 502 causes the request signal to be transmitted to the first communication terminal device 10a via the mobile communication unit 50 using mobile communication. The request signal may be configured similarly as above. Upon detection of a time over of the end-of-call wait timer, the detection unit 500 causes the monitor 58 to display a screen to let the user know that the reception of speech is terminated without an end-of-call notification being received. For example, the screen may be as shown in FIG. 5B. When the “reproduction request” shown in FIG. 5B is selected by the user operation unit 56, the request signal output unit 502 may cause the request signal to be transmitted to the first communication terminal device 10a via the mobile communication unit 50 using mobile communication.

When the business wireless communication unit 32 stops the transmission of the speech data, the request signal reception unit 310 of the first communication terminal device 10a receives the request signal from the second communication terminal device 10b via the mobile communication unit 30 using mobile communication. Upon receiving the request signal, the output unit 304 of the first communication terminal device 10a causes the mobile communication unit 30 to transmit the speech data acquired in the acquisition unit 314. In other words, the speech data is transmitted using mobile communication. In response to the transmitted request signal, the processing unit 54 of the second communication terminal device 10b receives the speech data from the first communication terminal device 10a via the mobile communication unit 50 using mobile communication.

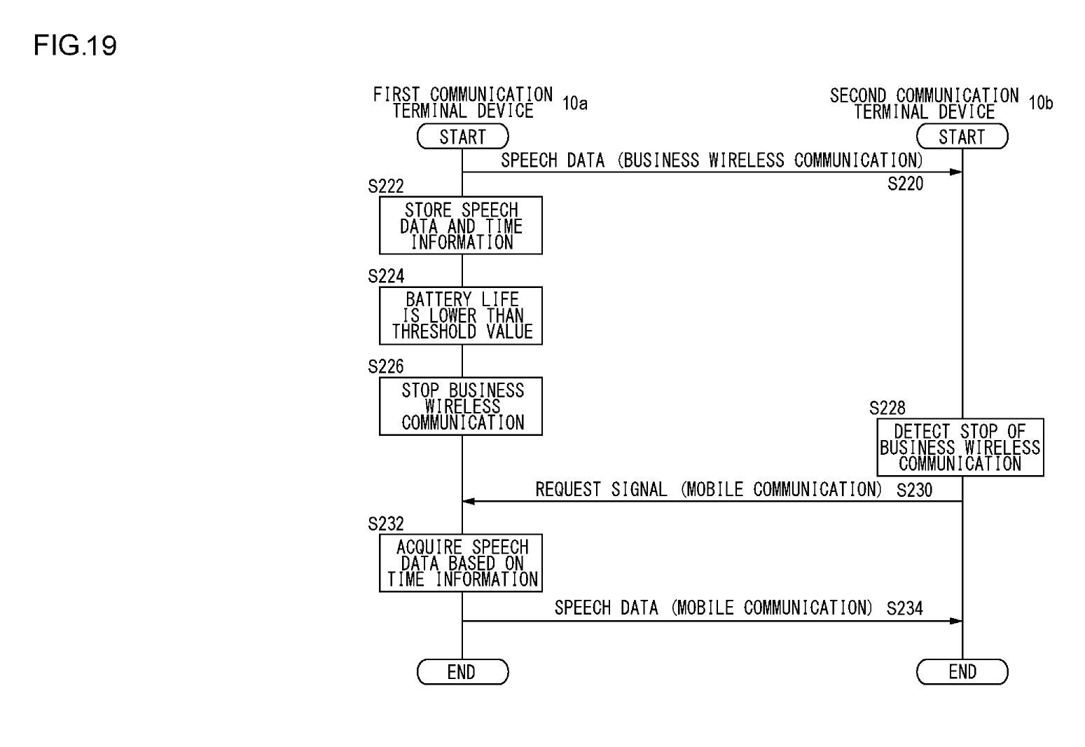

FIG. 19 is a sequence diagram showing the steps of transmitting the speech data by the communication system 100 according to Embodiment 5. The first communication terminal device 10a transmits the speech data to the second communication terminal device 10b using business wireless communication (S220). The first communication terminal device 10a stores the speech data and the time information (S222). Upon detecting that the remaining battery life goes lower than the threshold value (S224), the first communication terminal device 10a stops business wireless communication (S226). The second communication terminal device 10b detects the stop of business wireless communication (S228). The second communication terminal device 10b transmits a request signal to the first communication terminal device 10a using mobile communication (S230). The first communication terminal device 10a acquires the speech data based on the time information (S232). The first communication terminal device 10a transmits the speech data to the second communication terminal device 10b using mobile communication (S234).

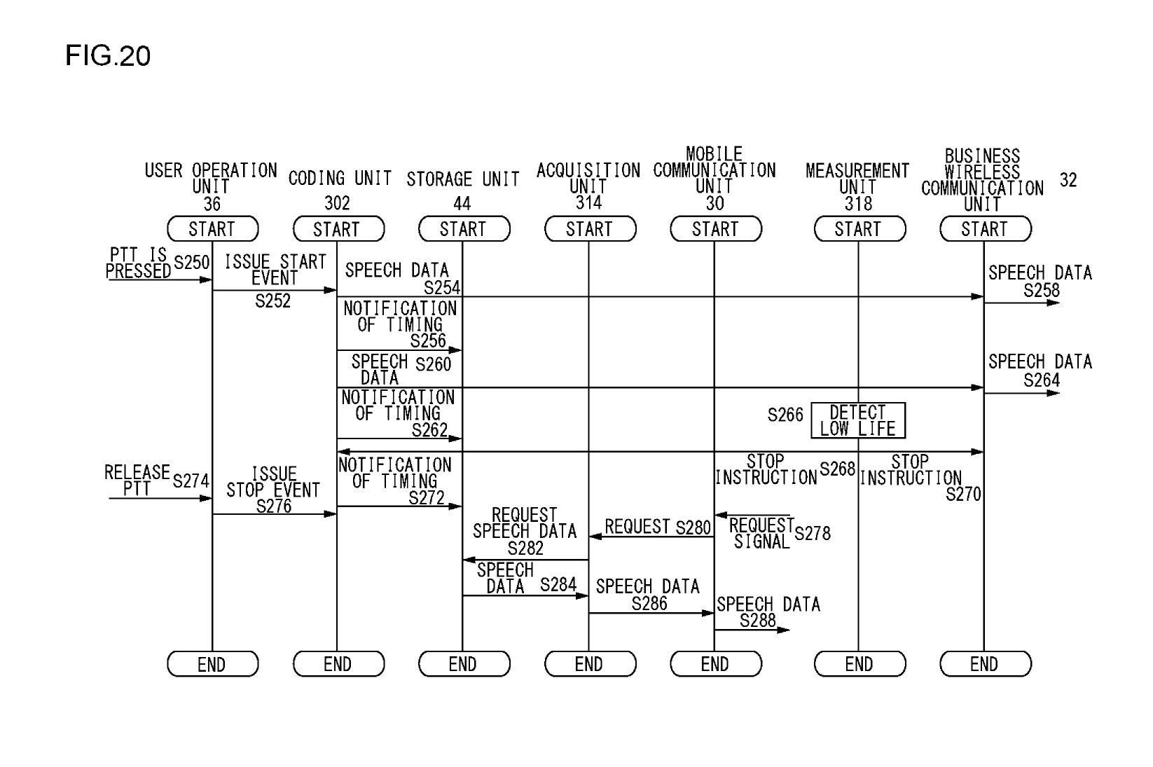

FIG. 20 is a sequence diagram showing the steps of transmitting the speech data by the first communication terminal device 10a according to Embodiment 5. The user operation unit 36 receives the pressing of the PTT button (S250). The user operation unit 36 issues a start event to the coding unit 302 (S252). The coding unit 302 outputs the speech data to the business wireless communication unit 32 (S254) and notifies the storage unit 44 of the timing for storage (S256). The storage unit 44 stores the speech data accordingly. The business wireless communication unit 32 transmits the speech data (S258). The coding unit 302 outputs the speech data to the business wireless communication unit 32 (S260) and notifies the storage unit 44 of the timing for storage (S262). The business wireless communication unit 32 transmits the speech data (S264).

When low remaining life is detected (S266), the stop unit 318 outputs a stop instruction to the coding unit 302 (S268) and outputs the stop instruction to the business wireless communication unit 32 (S270). The coding unit 302 notifies the storage unit 44 of the timing for storage (S272). The user operation unit 36 receives the release of the PTT button (S274). The user operation unit 36 issues a stop event to the coding unit 302 (S276). The mobile communication unit 30 receives the request signal (S278). The mobile communication unit 30 outputs the request to the acquisition unit 314 (S280). The acquisition unit 314 requests the storage unit 44 for the speech data (S282) and acquires the speech data from the storage unit 44 (S284). The acquisition unit 314 outputs the speech data to the mobile communication unit 30 (S286). The mobile communication unit 30 transmits the speech data (S288).

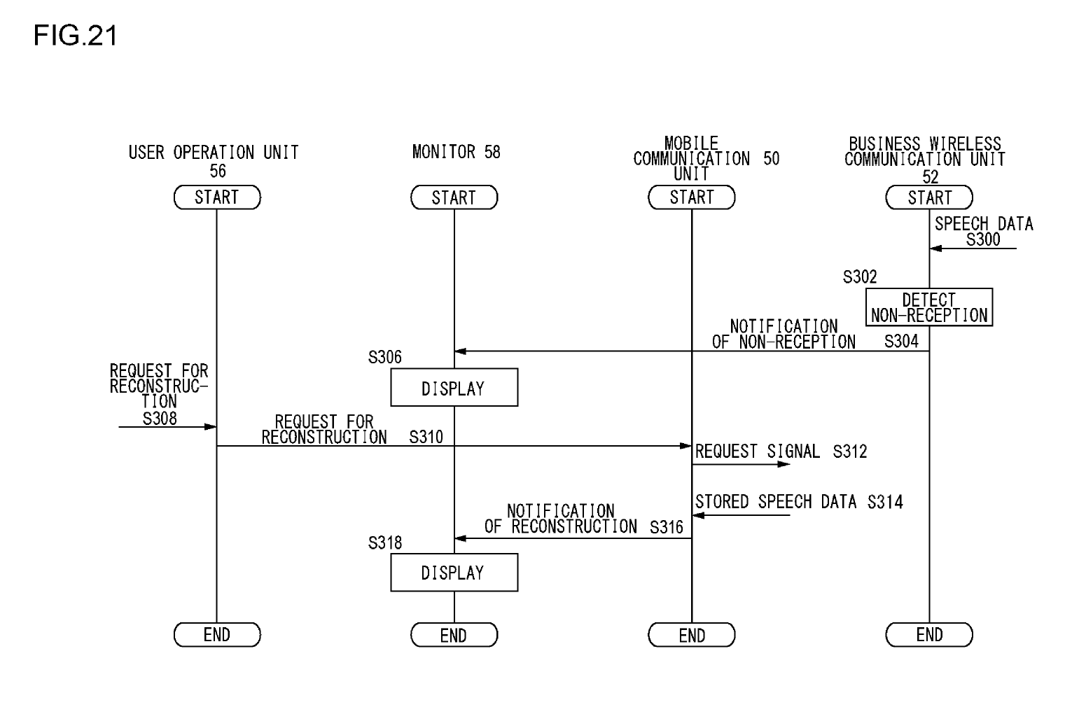

FIG. 21 is a sequence diagram showing the steps of receiving the speech data by the second communication terminal device 10b according to Embodiment 5. The business wireless communication unit 52 receives the speech data (S300). The business wireless communication unit 52 detects non-reception (S302). When non-reception is detected, the monitor 58 is notified of non-reception (S304). The monitor 58 displays non-reception (S306). A request for reconstruction is entered in the user operation unit 56 (S308). The user operation unit 56 outputs the request for reconstruction to the mobile communication unit 50 (S310) and the mobile communication unit 50 transmits a request signal (S312). The mobile communication unit 50 receives the stored speech data (S314). The mobile communication unit 50 outputs a notification of reconstruction to the monitor 58 (S316) and the monitor 58 displays reconstruction is proceeding (S318).

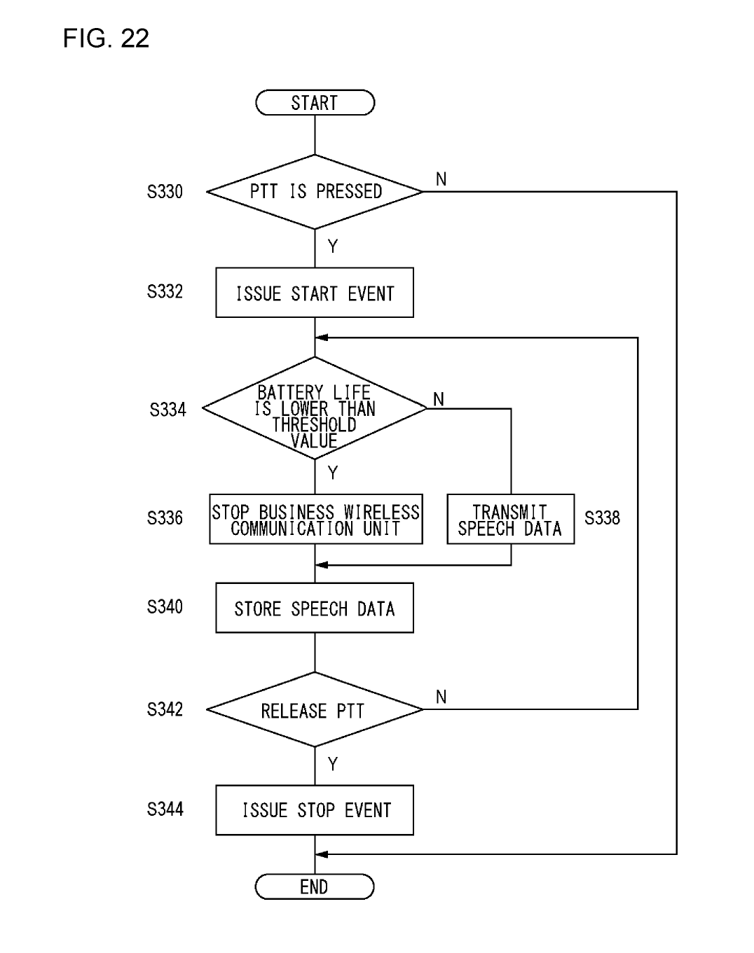

FIG. 22 is a flowchart showing the steps of generating speech data by the first communication terminal device 10a according to Embodiment 5. When the user operation unit 36 receives the pressing of the PTT button (Y in S330), a start event is issued (S332). When the measurement unit 316 detects that the remaining life is lower than the threshold value (Y in S334), the stop unit 318 stops the business wireless communication unit 32 (S336). When the measurement unit 316 detects that the remaining life is not lower than the threshold value (N in S334), the output unit 304 causes the business wireless communication unit 32 to transmit the speech data (S338). Subsequently, the write unit 308 causes the storage unit 44 to store the speech data (S340). When the user operation unit 36 does not receive the release of the PTT button (N in S342), control is returned to step 334. When the user operation unit 36 receives the release of the PTT button (Y in S342), a stop event is issued (S344). When the user operation unit 36 does not receive the pressing of the PTT button (N in S330), step 332 through step 344 are skipped.

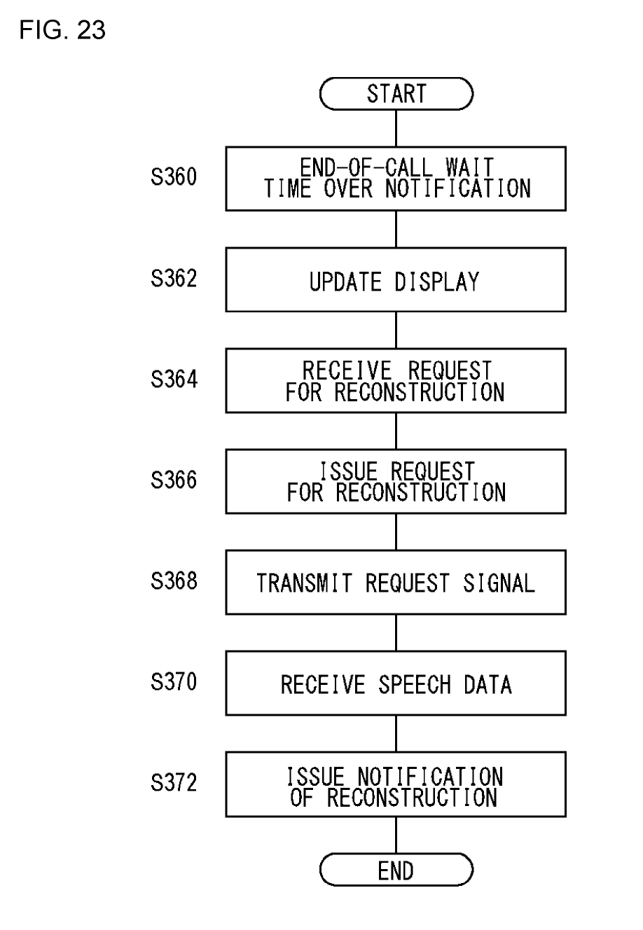

FIG. 23 is a flowchart showing the steps of receiving the speech data by the second communication terminal device 10b according to Embodiment 5. An end-of-call wait time over notification is issued (S360). The monitor 58 updates the display (S362). When the user operation unit 56 receives a request for reconstruction (S364), a reconstruction request is issued (S366). The mobile communication unit 50 transmits a request signal (S368). When the mobile communication unit 50 receives the speech data (S370), a notification of reconstruction is issued (S372).

The transmission power in mobile communication is smaller than the transmission power in business wireless communication. Thus, according to the embodiment, the period of time for battery-driven communication can be extended even when the battery life goes low while business wireless communication is used, by using mobile communication. Since the stored speech data is transmitted using mobile communication when the remaining battery life goes low, the speech data that could not have been sent using business wireless communication can be transmitted. In association with low battery life, the transmission of the speech data is stopped. However, the speech originated by the user of the first communication terminal device while the PTT is being pressed is stored so that the user of the second communication terminal device can hear the recorded speech later.

### Embodiment 6

A description will now be given of Embodiment 6. Like Embodiment 5, Embodiment 6 also relates to a communication system compatible with two communication schemes, i.e., business wireless embodiment) communication and mobile communication. Embodiment 6 also uses business wireless communication and mobile communication switchably depending on the remaining life of the battery driving the first communication terminal device, for the purpose of transmitting the speech data even when it is no longer possible to transmit using business wireless communication due to a low battery life. In Embodiment 5, a stop of transmission using business wireless communication in the first communication terminal device is detected by the second communication terminal device. In Embodiment 6, on the other hand, the first communication terminal device transmits a stop of transmission when stopping the transmission of the speech data using business wireless communication. By receiving the stop of transmission, the second communication terminal device recognizes the stop of transmission in the first communication terminal device using business wireless communication. The communication system, the first communication terminal device, and the second communication terminal device according to Embodiment 6 are of the same type as those of FIGS. 15, 17 and 18. The following description concerns a difference from the embodiments described above.

A description will be given of processes in the processing unit 34 in the first communication terminal device 10a and the processing unit 54 in the second communication terminal device 10b. When the stop unit 318 of the first communication terminal device 10a receives the notification from the measurement unit 316, the stop unit 318 causes the business wireless communication unit 32 to stop the transmission of the speech data. As a result, the business wireless communication unit 32 stops the transmission of the speech data using business wireless communication. The stop unit 318 also causes the mobile communication unit 30 or the business wireless communication unit 32 to transmit a stop of transmission. A stop of transmission is a signal to notify the second communication terminal device 10b that the transmission by the business wireless communication unit 32 is stopped.

The processing unit 54 of the second communication terminal device 10b receives the speech data from the first communication terminal device 10a via the business wireless communication unit 52 using business wireless communication. When the transmission of the speech data using business wireless communication is stopped in the first communication terminal device 10a, the detection unit 500 of the second communication terminal device 10b receives the stop of transmission via the mobile communication unit 50 or the business wireless communication unit 52. Upon receiving the stop of transmission, the mobile communication unit 50 communicates the stop of transmission to the request signal output unit 502. When the request signal output unit 502 of the second communication terminal device 10b is notified by the detection unit 500 of the stop of transmission, the request signal output unit 502 causes the request signal to be transmitted to the first communication terminal device 10a via the mobile communication unit 50 using mobile communication. The subsequent steps are as described above.

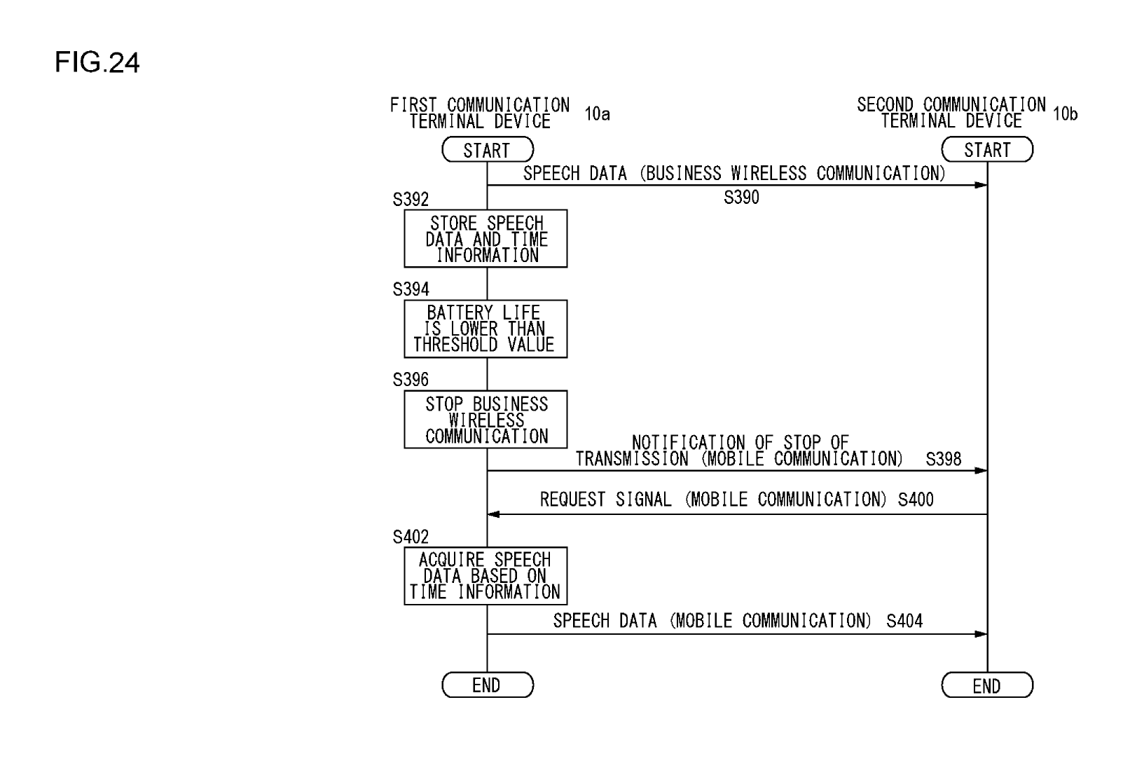

FIG. 24 is a sequence diagram showing the steps of transmitting the speech data by the communication system 100 according to Embodiment 6. The first communication terminal device 10a transmits the speech data to the second communication terminal device 10b using business wireless communication (S390). The first communication terminal device 10a stores the speech data and the time information (S392). Upon detecting that the remaining battery life goes lower than the threshold value (S394), the first communication terminal device 10a stops business wireless communication (S396). The first communication terminal device 10a transmits a stop of transmission to the second communication terminal device 10b using mobile communication (S398). The second communication terminal device 10b transmits a request signal to the first communication terminal device 10a using mobile communication (S400). The first communication terminal device 10a acquires the speech data based on the time information (S402). The first communication terminal device 10a transmits the speech data to the second communication terminal device 10b using mobile communication (S404).

The transmission power in mobile communication is smaller than the transmission power in business wireless communication. Thus, according to the embodiment, the period of time for battery-driven communication can be extended even when the battery life goes low while business wireless communication is used, by using mobile communication. Since a stop of transmission is communicated when business wireless communication is stopped, switching from business wireless communication to mobile communication can be communicated without fail. Since the stop of transmission is communicated, the process at the receiving end can be simplified.

Described above is an explanation based on an exemplary embodiment. The embodiment is intended to be illustrative only and it will be obvious to those skilled in the art that various modifications to constituting elements and processes could be developed and that such modifications are also within the scope of the present invention.

According to the embodiments, the communication system 100 uses business wireless communication. Alternatively, a wireless communication system other than business wireless communication may be used. According to this variation, the flexibility of the configuration can be improved.

According to the embodiments, the first communication terminal device 10a stores the speech data. Alternatively, the server device 20 may store the speech data generated in the first communication terminal device 10a. In this case, the second communication terminal device 10b transmits the request signal to the server device 20 and the server device 20 transmits the speech signal to the second communication terminal device 10b. According to this variation, the configuration of the communication terminal devices 10 can be simplified.

What is claimed is:

1. A communication terminal device comprising:
a reception unit that receives speech data to be transmitted;
a communication unit that transmits the speech data received in the reception unit;
a processing unit that divides the speech data received in the reception unit into a plurality of blocks and generates time information for identifying the blocks; and
a storage unit that stores the speech data divided by the processing unit and the generated time information, wherein
when the communication unit receives a request signal including time information identifying a point of time when communication quality is degraded, the processing unit acquires from the storage unit the speech data following a block identified based on the time information included in the received request signal and causes the communication unit to transmit the acquired speech data.

2. The communication terminal device according to claim 1, wherein
when the communication unit receives the request signal including the time information identifying the point of time when the communication quality is degraded, the processing unit revises the time information included in the received request signal to indicate earlier time.

3. The communication terminal device according to claim 1, wherein
the processing unit assigns numbering information for identifying blocks produced by dividing the received speech data into a plurality of blocks.

4. The communication terminal device according to claim 2, wherein
the processing unit assigns numbering information for identifying blocks produced by dividing the received speech data into a plurality of blocks.

5. The communication terminal device according to claim 1, wherein
the communication unit comprises:
a first communication unit that performs communication using a first communication scheme; and
a second communication unit that performs communication using a second communication scheme different from the first communication scheme in the first communication unit, wherein
the first communication unit is used to transmit the speech data received in the reception unit, and
when the first communication unit receives a request signal including time information identifying a point of time when communication quality is degraded, the processing unit acquires from the storage unit the speech data following a block identified based on the time information included in the received request signal and transmits the acquired speech data using the second communication unit.

6. The communication terminal device according to claim 2, wherein
the communication unit comprises:
a first communication unit that performs communication using a first communication scheme; and
a second communication unit that performs communication using a second communication scheme different from the first communication scheme in the first communication unit, wherein
the first communication unit is used to transmit the speech data received in the reception unit, and
when the first communication unit receives a request signal including time information identifying a point of time when communication quality is degraded, the processing unit acquires from the storage unit the speech data following a block identified based on the time information included in the received request signal and transmits the acquired speech data using the second communication unit.

7. The communication terminal device according to claim 3, wherein
the communication unit comprises:
a first communication unit that performs communication using a first communication scheme; and
a second communication unit that performs communication using a second communication scheme different from the first communication scheme in the first communication unit, wherein
the first communication unit is used to transmit the speech data received in the reception unit, and
when the first communication unit receives a request signal including time information identifying a point of time when communication quality is degraded, the processing unit acquires from the storage unit the speech data following a block identified based on the time information included in the received request signal and transmits the acquired speech data using the second communication unit.

8. The communication terminal device according to claim 4, wherein
the communication unit comprises:
a first communication unit that performs communication using a first communication scheme; and
a second communication unit that performs communication using a second communication scheme different from the first communication scheme in the first communication unit, wherein
the first communication unit is used to transmit the speech data received in the reception unit, and
when the first communication unit receives a request signal including time information identifying a point of time when communication quality is degraded, the processing unit acquires from the storage unit the speech data following a block identified based on the time information included in the received request signal and transmits the acquired speech data using the second communication unit.

9. A communication system comprising:
a first communication terminal device that receives speech data to be transmitted, transmits the received speech data, and stores, in a memory, the speech data and time information for identifying blocks produced by dividing the received speech data into a plurality of blocks; and
a second communication terminal device that receives the speech data from the first communication terminal device, detects degradation in communication quality of the received speech data, and transmits a request signal including time information identifying a point of time when the communication quality is degraded, wherein
the first communication terminal device receives the request signal transmitted from the second communication terminal device, acquires, from the memory, the speech data for the block identified based on the time information included in the received request signal, and transmits the acquired speech data.

10. A communication method comprising:
receiving speech data to be transmitted;
transmitting received speech data;
dividing the received speech data into a plurality of blocks and generating time information for identifying the blocks;
storing the divided speech data and the generated time information in a memory; and
when a request signal including time information identifying a point of time when communication quality is degraded is received, acquiring from the memory the speech data following a block identified based on the time information included in the received request signal, and transmitting the acquired speech data.

11. A non-transitory computer-readable recording medium having embedded thereon a program,
the program comprising:
a module that receives speech data to be transmitted;
a module that transmits received speech data;
a module that divides the received speech data into a plurality of blocks and generating time information for identifying the blocks;
a module that stores the divided speech data and the generated time information in a memory; and
when a request signal including time information identifying a point of time when communication quality is degraded is received, acquiring from the memory the speech data following a block identified based on the time information included in the received request signal, and transmitting the acquired speech data.
